(19) United States
(12) Patent Application Publication
(10) Pub. No.: US 2002/0156741 A1
(43) Pub. Date: Oct. 24, 2002

(54) Feature-dependent charge assessment method and apparatus

(75) Inventor: Itaru Furukawa, Kyoto (JP)

Correspondence Address: McDermott, Will & Emery, 600 13th Street, N.W., Washington, DC, 20005-3096, US

(73) Assignee: DAINIPPON SCREEN MFG. CO., LTD.

(21) Appl. No.: 10/126,590

(22) Filed: Apr. 22, 2002

(30) Foreign Application Priority Data
Apr. 23, 2001 (JP) 2001-123991

(51) Int. Cl. H04L 9/00; H04K 1/00

(52) U.S. Cl. 705/52

(57) ABSTRACT

Responsive to input of an instruction for use of at least one feature of a managed apparatus 610, a usage management apparatus 110 investigates to determine the amount or amounts of a ticket balance or balances authorizing use of such feature or features, and if such amount or amounts is or are sufficient for the use for which such instruction was input, then the managed apparatus 610 may be made to execute such feature or features. If the ticket balance or balances is or are less than the required amount or amounts, a request may be made by way of, for example, the Internet 700 for a server 200 to issue one or more tickets for such feature or features in accordance with one or more ticket acquisition instructions from a user. Responsive to issuance of such ticket or tickets, one or more ticket balances for such feature or features may be increased, permitting use of such feature or features at the managed apparatus 610 in accordance with the instruction for use thereof. Based on such ticket issuance, the server 200 may carry out charge assessment for use of such feature or features at the managed apparatus 610. Feature-dependent charge assessment may thus be carried out with respect to use of such a managed apparatus

### CROSS-REFERENCE TO RELATED APPLICATION AND CLAIM TO RIGHT OF FOREIGN PRIORITY DATE

This application claims the right of benefit of prior filing date of Japanese Patent Application No. 2001-123991, filed Apr. 23, 2001, entitled “Feature-Dependent Charge Assessment Method and Apparatus,” the content of which is incorporated herein by reference in its entirety.

### STATEMENT REGARDING FEDERALLY SPONSORED RESEARCH OR DEVELOPMENT

Not applicable.

### BACKGROUND

The present invention pertains to a method and apparatus for assessing charges for use of any of a variety of apparatus and software products. Among other benefits, the present invention allows assessment of charges with respect to usage of a product to be carried out in correspondence to the manner of usage thereof, e.g., through feature-dependent metered usage of that product, so as to, for example, permit the product to be used at low cost despite the product's being used in a variety of ways and/or despite changes in the manner in which the product is used.

Various apparatuses and software items used by society are made available as products by manufacturers and are purchased by corporate, individual, and other such users who desire to use them. Furthermore, especially with respect to apparatuses and other such products for business use, such use may occur in the context of arrangements whereby a leasing company, for example, purchases a product and the user of that product makes periodic payment of a lease fee (rental fee) to the leasing company.

While the products provided to and used by society typically possess a plurality of features, it often happens that a user of such a product will not use all of that product's features but only some portion of them. And while an apparatus, for example, acquired by a factory, office, or the like through purchase or lease may possess adequate features at the time of acquisition, it is entirely possible that a feature not present in the acquired apparatus will later become necessary due to changes in the nature of the work performed at the factory or the like, in which case new acquisition must be made of an apparatus possessing the necessary feature.

To prevent a situation where an excessive number of the features of an acquired apparatus go unused, a manufacturer might develop a large number of models or versions to suit the many ways in which the apparatus is or will be used by its various users. However, it is in practice impossible to provide all of the equipment models or the like that would be necessary to accommodate the many different manners of usage of all of the various users, and an increased number of models would tend to increase development cost and maintenance cost. Furthermore, even where a user was able to minimize acquisition cost through acquisition of an apparatus having only the required feature or features, the fact that a new apparatus would have to be acquired if a new feature later became necessary means that the user ultimately stands to bear a large cost burden. And it is also possible that a feature necessary at the time that an apparatus was acquired becomes unnecessary at a time after acquisition, in which case any cost burden represented by the unnecessary feature would go to waste.

### SUMMARY

It is therefore an object of the present invention to provide a method and apparatus for permitting assessment of charges with respect to usage of a product to be carried out in correspondence to the manner of usage thereof, e.g., through feature-dependent metered usage of that product, so as to, for example, permit the product to be used at low cost despite the product's being used in a variety of ways and/or despite changes in the manner in which the product is used.

One aspect of the invention is a charge assessment method carried out in the context of a system comprising a server which carries out charge assessment processing with respect to usage of a product having a plurality of features and a usage management apparatus which manages usage of the product and which is connected so as to be capable of communication with the server.

Such method may comprise a usage amount management step wherein at least one amount of usage of the product is managed at the usage management apparatus in feature-dependent fashion.

Such method may furthermore comprise a sending step wherein usage amount information indicating at least one feature-dependent usage amount of the product is sent from the usage management apparatus to the server before-the-fact if for a contemplated future use or after-the-fact if for a completed past use.

Such method may furthermore comprise a fee calculation step wherein a fee for usage of the product is calculated at the server in feature-dependent fashion based on the usage amount information.

Such method may furthermore comprise a ticket issuing step wherein at least one ticket authorizing at least one specific feature-dependent amount of usage of the product is issued from the server to the usage management apparatus.

Such method may furthermore comprise a determination step wherein at least one usage amount for the product managed in feature-dependent fashion is treated as an authorized usage amount for a contemplated future use, and in response to a request from a user of the product for use of one or more of the plurality of features of the product a determination is made as to whether to permit use based on at least one authorized usage amount for at least one of the feature or features requested to be used.

Such method may furthermore comprise a usage authorization step wherein usage of at least one of the feature or features requested for use is authorized at the usage management apparatus only if it has been determined at the determination step that use of the feature or features is permitted.

The sending step may be such that an issuance request requesting issuance of at least one ticket authorizing at least one specific amount of use of at least one specific feature of the product is sent to the server before-the-fact as usage amount information for a contemplated future use.

The ticket issuing step may be such that ticket data electronically representative of the at least one ticket requested to be issued in the issuance request is sent from the server to the usage management apparatus in response to receipt of the issuance request at the server.

The fee calculation step may be such that a fee for use of the at least one specific feature indicated by the ticket data which was sent is calculated based on the ticket data.

The usage amount management step may comprise an upward revision step wherein responsive to receipt of the ticket data at the usage management apparatus at least one authorized usage amount of at least one of the plurality of features of the product which is a specific feature indicated by the received ticket data is increased by a specific amount indicated by the received ticket data.

The usage amount management step may furthermore comprise a downward revision step wherein responsive to use of at least one of the plurality of features of the product the authorized usage amount of the at least one used feature is reduced by the amount that it was used.

Another aspect of the invention is a method for causing a server connected so as to be capable of communication with a usage management apparatus which manages usage of a product having a plurality of features to carry out charge assessment processing with respect to usage of the product.

Such method may comprise a receiving step wherein usage amount information indicating at least one feature-dependent usage amount of the product is received from the usage management apparatus.

Such method may furthermore comprise a fee calculation step wherein a fee for usage of the product is calculated in feature-dependent fashion based on the usage amount information.

Such method may furthermore comprise a ticket issuing step wherein at least one ticket authorizing at least one specific feature-dependent amount of usage of the product is issued.

The receiving step may be such that an issuance request requesting issuance of at least one ticket authorizing at least one specific amount of use of at least one specific feature of the product is received as usage amount information.

The ticket issuing step may be such that ticket data electronically representative of the at least one ticket requested to be issued in the issuance request is sent to the usage management apparatus in response to receipt of the issuance request.

The fee calculation step may be such that a fee for use of the at least one specific feature indicated by the ticket data which was sent is calculated based on the ticket data.

Such method may furthermore comprise an issuance history data storage step wherein ticket issuance history data comprising information indicating at least one product, at least one specific feature, and at least one specific amount for which use is authorized by the at least one ticket issued at the ticket issuing step is stored.

Such method may furthermore comprise an arrival history data receiving step wherein ticket arrival history data comprising information indicating at least one product, at least one specific feature, and at least one specific amount for which use is authorized by ticket data received at the usage management apparatus is received from the usage management apparatus.

Such method may furthermore comprise a comparing step wherein the stored ticket issuance history data and the received ticket arrival history data are mutually compared.

Such method may furthermore comprise an issuance history data storage step wherein ticket issuance history data comprising information indicating at least one product, at least one specific feature, and at least one specific amount for which use is authorized by the at least one ticket issued at the ticket issuing step is stored.

Such method may furthermore comprise a usage history data receiving step wherein usage history data comprising information indicating at least one product managed by the usage management apparatus and indicating at least one completed past feature-dependent usage amount of the managed product is received from the usage management apparatus.

Such method may furthermore comprise a comparing step wherein the stored ticket issuance history data and the received usage history data are mutually compared.

Such method may furthermore comprise a usage history data receiving step wherein usage history data comprising information indicating at least one product managed by the usage management apparatus and indicating at least one completed past feature-dependent usage amount of the managed product is received from the usage management apparatus.

Another aspect of the invention is a method for causing a usage management apparatus connected so as to be capable of communication with a server which carries out charge assessment processing with respect to usage of a product having a plurality of features to manage usage of the product.

Such method may comprise a usage amount management step wherein at least one amount of usage of the product is managed in feature-dependent fashion.

Such method may furthermore comprise a sending step wherein usage amount information indicating at least one feature-dependent usage amount of the product is sent to the server before-the-fact if for a contemplated future use or after-the-fact if for a completed past use.

Such method may furthermore comprise a determination step wherein at least one usage amount for the product managed in feature-dependent fashion is treated as an authorized usage amount for a contemplated future use, and in response to a request from a user of the product for use of one or more of the plurality of features of the product a determination is made as to whether to permit use based on at least one authorized usage amount for at least one of the feature or features requested to be used.

Such method may furthermore comprise a usage authorization step wherein usage of at least one of the feature or features requested for use is authorized only if it has been determined at the determination step that use of the feature or features is permitted.

The sending step may be such that an issuance request requesting issuance of at least one ticket authorizing at least one specific amount of use of at least one specific feature of the product is sent before-the-fact as usage amount information for a contemplated future use.

The usage amount management step may comprise a receiving step wherein ticket data electronically representative of the at least one ticket issued by the server in response to the issuance request is received.

The usage amount management step may furthermore comprise an upward revision step wherein responsive to receipt of the ticket data at the receiving step at least one authorized usage amount of at least one of the plurality of features of the product which is a specific feature indicated by the received ticket data is increased by a specific amount indicated by the received ticket data.

The usage amount management step may furthermore comprise a downward revision step wherein responsive to use of at least one of the plurality of features of the product the authorized usage amount of the at least one used feature is reduced by the amount that it was used.

Such method may furthermore comprise an arrival history data storage step wherein ticket arrival history data comprising information indicating at least one product, at least one specific feature, and at least one specific amount for which use is authorized by ticket data received at the usage management apparatus is stored.

Such method may furthermore comprise an arrival history data sending step wherein the stored ticket arrival history data is sent to the server.

Such method may furthermore comprise a usage history data storage step wherein usage history data comprising information indicating at least one product managed by the usage management apparatus and indicating at least one completed past feature-dependent usage amount of the managed product is stored.

Such method may furthermore comprise a usage history data sending step wherein the stored usage history data is sent to the server.

Such method may furthermore comprise a usage history data storage step wherein usage history data comprising information indicating at least one product managed by the usage management apparatus and indicating at least one completed past feature-dependent usage amount of the managed product is stored.

Such method may furthermore comprise a usage history data sending step wherein the stored usage history data is sent to the server.

Another aspect of the invention is a program for causing a computer to execute any one or more of the above methods.

Such a computer may be connected so as to be capable of communication with the server.

Such a computer may function as the usage management apparatus.

Another aspect of the invention is a usage management apparatus which is connected so as to be capable of communication with a server that carries out charge assessment processing with respect to usage of a product having a plurality of features and which manages usage of the product.

Such usage management apparatus may comprise usage amount management means for managing at least one usage amount of the product in feature-dependent fashion.

Such usage management apparatus may furthermore comprise sending means for sending to the server, before-the-fact if for a contemplated future use or after-the-fact if for a completed past use, usage amount information indicating at least one feature-dependent usage amount of the product.

Such usage management apparatus may furthermore comprise determination means for treating at least one usage amount for the product managed in feature-dependent fashion by the usage amount management means as an authorized usage amount for a contemplated future use, and for, in response to a request from a user of the product for use of one or more of the plurality of features of the product, determining whether to permit use based on at least one authorized usage amount for at least one of the feature or features requested to be used.

Such usage management apparatus may furthermore comprise usage authorization means for authorizing usage of at least one of the feature or features requested for use only if the determination means has determined that use of the feature or features is permitted.

The sending means may send before-the-fact as usage amount information for a contemplated future use an issuance request requesting issuance of at least one ticket authorizing at least one specific amount of use of at least one specific feature of the product.

The usage amount management means may comprise receiving means for receiving ticket data electronically representative of the at least one ticket issued by the server in response to the issuance request.

The usage amount management means may furthermore comprise upward revision means for, responsive to receipt of the ticket data by the receiving means, increasing by a specific amount indicated by the received ticket data at least one authorized usage amount of at least one of the plurality of features of the product which is a specific feature indicated by the received ticket data.

The usage amount management means may furthermore comprise downward revision means for, responsive to use of at least one of the plurality of features of the product, reducing the authorized usage amount of the at least one used feature by the amount that it was used.

By “completed past” and “after-the-fact” it is not intended that features currently in use should be excluded from the purview of the present invention; for the purposes of the present invention “completed past” and “after-the-fact” mean that initiation of use of the applicable feature or features occurred in the past, regardless of whether that use had terminated or was still ongoing at the time of the event in question, such that the combination of the terms “contemplated future” and “completed past,” and the combination of the terms “before-the-fact” and “after-the-fact,” respectively comprehend all possible times of use.

In accordance with one or more embodiments of the present invention, because charge assessment with respect to usage of a product having a plurality of features is carried out in feature-dependent fashion, the selling price of the product can be kept low and unproductive costs associated with unused features can be minimized. This allows the user to enjoy reduced initial and ongoing costs despite acquisition of an apparatus or other such product equipped with more features than necessary at the time of acquisition, and yet have the ability to use one or more of the previously unused features as the need arises. Furthermore, because in at least one embodiment of the present invention charge assessment is carried out in correspondence to usage amount in feature-dependent fashion, assessed charges may be reduced in correspondence to usage amount when one or more previously heavily used features are later used less than they formerly were, and/or assessed charges may be such that no charge is assessed for one or more features which although formerly used are at a later time not used at all. Where there is a change in the feature or features which are required or in the amount or amounts of usage thereof at an apparatus or other such acquired product, the present invention thus permits reduction in unproductive and excessive costs incurred due such change. Furthermore, because products having an abundance of features can be sold at low price based on the assumption that charge assessment will be carried out in correspondence to usage of the product following sale, this allows the manufacturer of such a product to enjoy the benefit of being able to accommodate the needs of a wide variety of customers while keeping the number of models or versions to a minimum.

Furthermore, enjoyment of one or more benefits similar to those described above is permitted by the fact that in one or more embodiments of the present invention an issuance request requesting issuance of one or more tickets authorizing at least one specific amount of use of at least one specific feature of a product is sent to a server as usage amount information and a fee for use of at least one of the specific feature or features is calculated based on ticket data sent from the server to the usage management apparatus in response thereto. Furthermore, because in at least one embodiment of the present invention fee calculation for assessment of charges for use of a product is carried out at a server based on one or more tickets issued prior to occurrence of actual use, assured collection of the usage fee is permitted. Moreover, because in at least one embodiment of the present invention a usage management apparatus manages at least one usage amount authorized in feature-dependent fashion by means of one or more authorized usage amounts through issuance of one or more tickets and a determination is made with regard to whether to enable usage of a product based on at least one such authorized usage amount, the usage management apparatus need not communicate with a server every time that the product is used, permitting reduction in the amount of communication between server and usage management apparatus.

Furthermore, because in at least one embodiment of the present invention ticket issuance history data stored at a server and ticket arrival history data sent from the usage management apparatus to the server are mutually compared, investigation to determine whether fraudulent use of a product has occurred is permitted.

Moreover, because in at least one embodiment of the present invention ticket issuance history data stored at a server and usage history data sent from the usage management apparatus to the server are mutually compared, investigation to determine whether fraudulent use of a product has occurred is permitted.

Furthermore, because in at least one embodiment of the present invention usage history data indicating a feature-dependent usage history of a product is received at a server from a usage management apparatus, collection and analysis of such usage history data may be carried out, making it possible, for example, to obtain marketing information, information capable of being used in connection with setting of fees and/or discounts for one or more users, and/or information capable of being used in connection with maintenance and/or repair of one or more managed apparatuses.

### BRIEF DESCRIPTION OF DRAWINGS

These and other features, aspects, and advantages of the present invention will become better understood with reference to the following description, appended claims, and accompanying drawings where:

FIG. 1 is a block diagram showing the overall constitution of a feature-dependent charge assessment system associated with a first embodiment of the present invention;

FIG. 2A is a block diagram showing an example of one possible hardware constitution of usage management apparatuses in accordance with the first embodiment;

FIG. 2B is a block diagram showing an example of another possible hardware constitutions of usage management apparatuses in accordance with the first embodiment;

FIG. 3 is a block diagram showing the constitution of a scanner for business use which represents a specific example of a managed apparatus in accordance with the first embodiment;

FIG. 4 is a drawing showing identification information maintained at a usage management apparatus in accordance with the first embodiment;

FIG. 5 is a drawing showing ticket management information maintained at a usage management apparatus in accordance with the first embodiment;

FIG. 6 is a drawing showing identification information maintained at a server in accordance with the first embodiment;

FIG. 7 is a drawing showing contract information maintained at a server in accordance with the first embodiment;

FIG. 8 is a functional block diagram of a usage management apparatus and a managed apparatus in accordance with the first embodiment;

FIG. 9 is a functional block diagram of a server in accordance with the first embodiment;

FIG. 10A is a flowchart showing operations occurring at a usage management apparatus during startup thereof in accordance with the first embodiment;

FIG. 10B is a flowchart showing operations occurring at a server during startup of the usage management apparatus in accordance with the first embodiment;

FIG. 11A is a flowchart showing operations occurring during server verification processing in accordance with the first embodiment;

FIG. 11B is a flowchart showing operations occurring during managed apparatus verification processing in accordance with the first embodiment;

FIG. 12A is a flowchart showing operations occurring at a usage management apparatus at a time of use of one or more features of the managed apparatus in accordance with the first embodiment;

FIG. 12B is a flowchart showing operations occurring at a server at a time of use of one or more features of the managed apparatus in accordance with the first embodiment;

FIG. 13A is a flowchart showing operations occurring at a usage management apparatus during ticket acquisition processing in accordance with the first embodiment;

FIG. 13B is a flowchart showing operations occurring at a server during ticket issuance processing in accordance with the first embodiment;

FIG. 14A is a flowchart showing operations occurring at a usage management apparatus during ticket acquisition processing in accordance with a second embodiment of the present invention;

FIG. 14B is a flowchart showing operations occurring at a server during ticket issuance processing in accordance with the second embodiment of the present invention;

FIG. 15 is a functional block diagram showing exemplary components for implementing customer-side history comparison functionality in accordance with the second embodiment;

FIG. 16 is a functional block diagram showing exemplary components for implementing server-side history comparison functionality in accordance with the second embodiment;

FIG. 17A is a flowchart showing operations occurring at a usage management apparatus during processing for comparing ticket histories in accordance with the second embodiment; and

FIG. 17B is a flowchart showing operations occurring at a server during processing for comparing ticket histories in accordance with the second embodiment.

### DESCRIPTION

The present invention pertains to a method and apparatus for carrying out assessment of charges for use of an apparatus, software, or other such product having a plurality of features. In a charge assessment system associated with one or more of the embodiments of the present invention described below, a product for which charge assessment is carried out (hereinafter “managed product”) may be sold at a price lower than would otherwise be the case, with assessment of charges for use of the product by a customer, e.g., the purchaser of the product, being carried out in feature-dependent fashion upon use of the product following such sale.

Below, several exemplary embodiments of the present invention are described in detail with reference to the attached drawings.

1. First Embodiment

1.1. Constitution

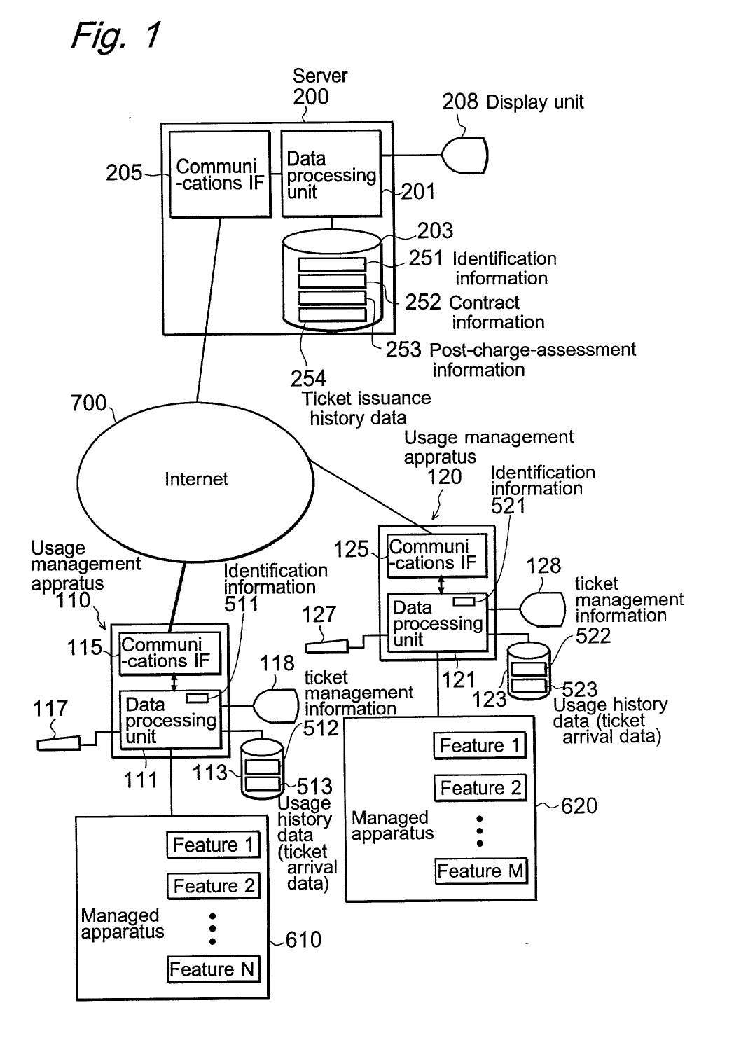

FIG. 1 is a block diagram showing the overall constitution of a feature-dependent charge assessment system associated with a first embodiment of the present invention. This feature-dependent charge assessment system comprises, for example, a first and a second usage management apparatus 110, 120 for respectively managing apparatuses (hereinafter “managed apparatuses”) 610, 620, each having a plurality of features and each representing a managed product; a server computer (hereinafter “server”) 200 installed, for example, at the company which sold the managed apparatuses 610, 620; and, for example, the Internet 700, which connects the usage management apparatuses 110, 120 such that they are capable of communication with the server 200. Note that whereas in the example presented at FIG. 1 two usage management apparatuses are shown, the present invention is not limited to applications in which there are two managed apparatuses (managed products), it also being possible to apply the present invention where there is one managed product or where there is any number of managed products. Furthermore, note that the present invention is not limited to applications in which the Internet is the means employed for connecting the usage management apparatuses 110, 120 so as to be capable of communication with the server 200, it being possible to alternatively or in addition employ other communication means to connect the usage management apparatuses 110, 120 with the server 200.

1.1.1. Hardware Components of Usage Management Apparatus

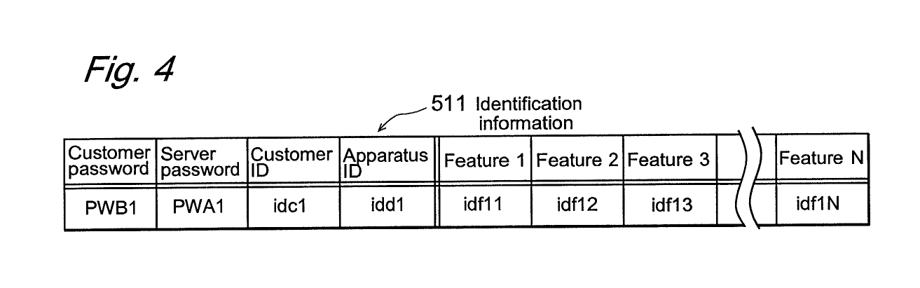

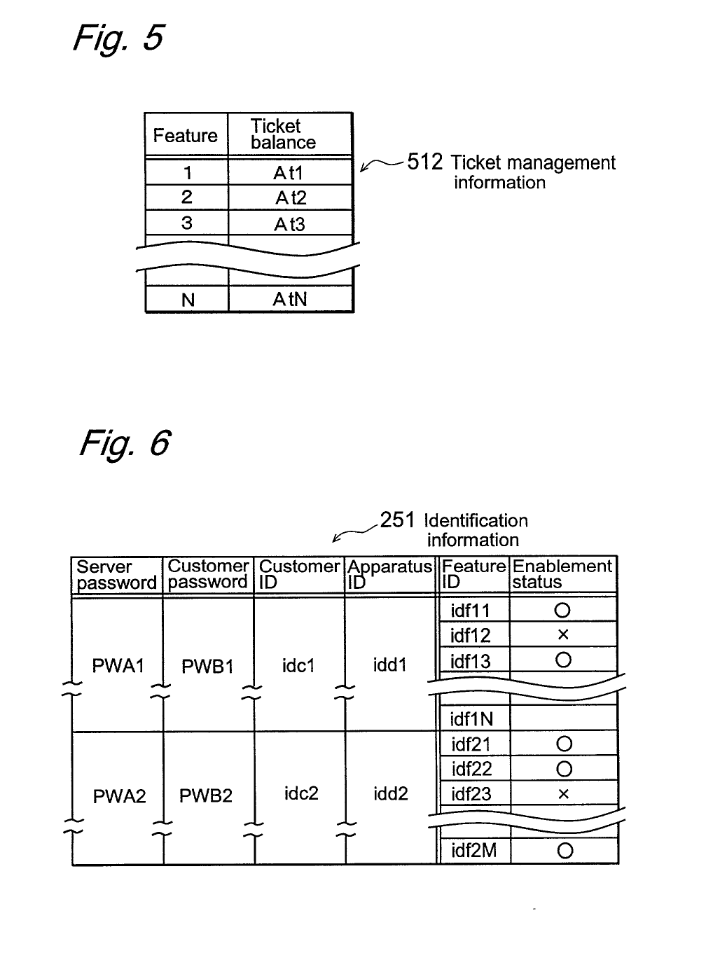

With continued reference to FIG. 1, the first usage management apparatus 110 of the feature-dependent charge assessment system, being an apparatus for managing use of a managed apparatus 610 which has, for example, N features numbered here for convenience as feature 1 through feature N, comprises a data processing unit 111 comprising a central processing unit (hereinafter “CPU”), memory, and so forth; an external storage unit 113 comprising, for example, a hard drive unit; a communications interface unit (hereinafter “communications IF”) 115 comprising, for example, a modem permitting communication with the server 200 by way of the Internet 700; an input unit 117 comprising, for example, a keyboard, mouse, and/or the like; and a display unit 118 implemented by means of, for example, a CRT, liquid crystal display, or the like. The data processing unit 111, besides having a clock function for obtaining time information for inclusion in history data, described below, comprises a nonvolatile read only memory. As will be described in further detail below with reference to FIG. 4, prestored at this nonvolatile memory as identification information 511 are an apparatus ID, one or more customer IDs, and feature IDs for respectively identifying the managed apparatus 610, at least one customer using the managed apparatus 610, and various features 1 through N which the managed apparatus 610 possesses. Furthermore, the external storage unit 113 is capable of storing ticket management information 512 and usage history data 513. As will be described in further detail below with reference to FIG. 5, the ticket management information 512 in the present example refers to information for management of one or more tickets issued by the server 200 for authorizing at least one specific amount of use of at least one specific feature of the various features 1 through N which the managed apparatus 610 possesses, a specific example of which would be information indicating an unused portion (hereinafter “ticket balance”) of an authorized usage amount, e.g., in the form of some number of usage incidents or other such usage units, for a feature whose use has been authorized based on one or more previously issued tickets. Furthermore, the usage history data 513 contains usage histories for the various features 1 through N which the managed apparatus 610 possesses, a specific example of which would be data comprising zero or more feature IDs identifying any features which have actually been used, any applicable times of use, any applicable usage amounts, and any applicable customer IDs identifying any applicable users.

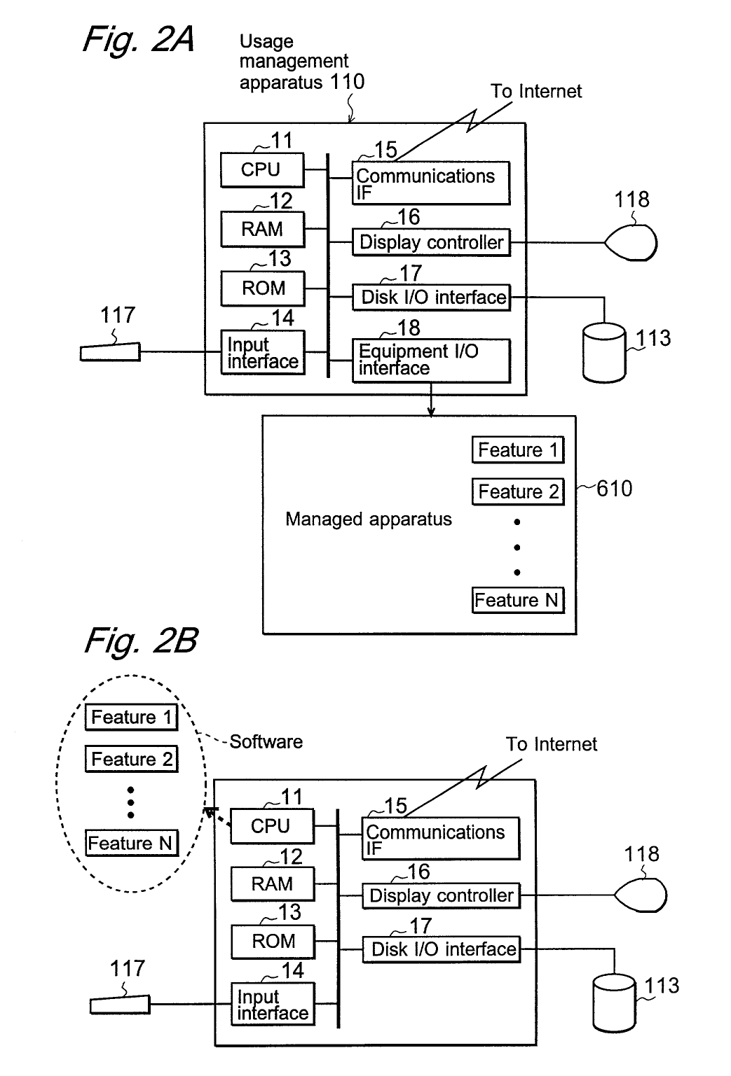

Referring now to FIG. 2A, this is a block diagram showing an example of one possible constitution for the usage management apparatus 110. In the present example, the usage management apparatus 110 is for example implemented in the context of a personal computer (hereinafter “PC”), the data processing unit 111 at the interior of the usage management apparatus 110 comprises a CPU 11, a random access memory (hereinafter “RAM”) 12 which serves as working memory, a read only memory (hereinafter “ROM”) 13 which serves as nonvolatile memory, an input interface 14 to which the input unit 117 can be connected, a display controller 16 to which a display unit 118 can be connected, a disk I/O interface 17 to which a hard drive unit serving as the external storage unit 113 can be connected, and an equipment I/O interface 18 to which a managed apparatus 610 can be connected. Furthermore, communications IF 15 in the block diagram at FIG. 2A corresponds to the communications IF 115 in the block diagram at FIG. 1. Moreover, whereas in the present example the identification information 511 is stored in ROM 13, the present invention is not limited thereto, it being possible to alternatively or in addition store the identification information 511 in, for example, an invisible file at the hard drive unit.

Referring now to FIG. 2B, this drawing shows one possible constitution for a usage management apparatus when the managed product in the feature-dependent charge assessment system shown at FIG. 1 is not a hardware product but is instead a software product (e.g., an application program). In the present example, an application program serving as managed product and prestored at a hard drive unit 113 serving as external storage unit is at a time of use loaded into RAM 12 from the hard drive unit 113 and is executed by a CPU 11. Processing may as a result be carried out that causes at least one of the features 1 through N which the application program possesses to be made available to a user. Accordingly, unlike the example described with reference to FIG. 2A, the data processing unit 111 in the present example need not comprise an equipment I/O interface 18. Furthermore, as described in further detail below, the managed product may be an apparatus or virtual apparatus implemented through combination of hardware and software elements.

Referring again to FIG. 1, the second usage management apparatus 120 of the feature-dependent charge assessment system, being an apparatus for managing use of a managed apparatus 620 which has, for example, M features numbered here for convenience as feature 1 through feature M, comprises a data processing unit 121, an external storage unit 123, a communications interface unit (“communications IF”) 125, an input unit 127, and a display unit 128. The data processing unit 121, besides having a clock function for obtaining time information for inclusion in history data, described below, comprises a nonvolatile read only memory. Prestored at this nonvolatile memory are an apparatus ID, one or more customer IDs, and feature IDs for respectively identifying the managed apparatus 620, at least one customer using the managed apparatus 620, and various features 1 through M which the managed apparatus 620 possesses. Furthermore, the external storage unit 123 is capable of storing ticket management information 522 and usage history data 523. As the various components of the second usage management apparatus 120 are substantially identical to those described with reference to the first usage management apparatus 110, detailed explanation thereof will be omitted here.

Note that while two usage management apparatuses are shown in the example at FIG. 1, in the description that follows description is for convenience made only with respect to the usage management apparatus 110 which manages managed apparatus 610, but such description should be understood to apply in representative fashion to as many usage management apparatuses as are present.

1.1.2. Specific Example of Managed Apparatus

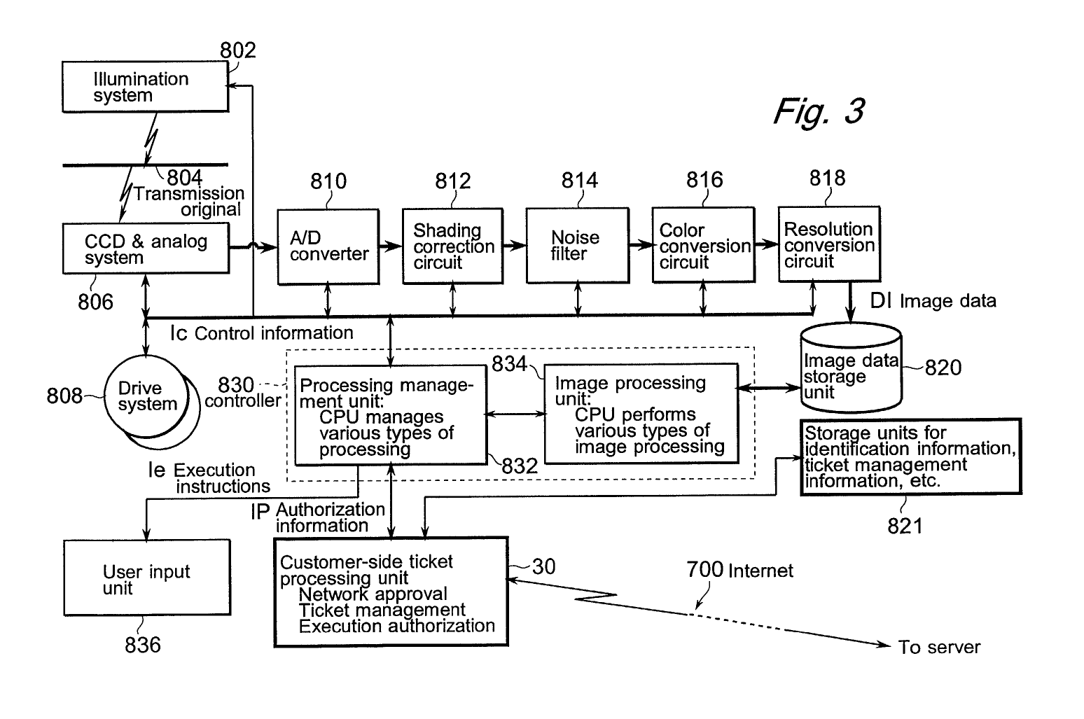

FIG. 3 is a block diagram showing the constitution of a scanner for business use which represents a specific example of a managed apparatus in a feature-dependent charge assessment system associated with the present embodiment.

This scanner, being an apparatus for generating image data captured from a hardcopy or other such original image, comprises an illumination system 802; an image capturing circuit 806 comprising a charge coupled device (“CCD”) and an analog circuit capable of processing a signal output from the CCD; a drive system 808; an analog/digital converter (“A/D converter”) 810; a shading correction circuit 812; a noise filter 814; a color conversion circuit 816; a resolution conversion circuit 818; an image data storage unit 820; a controller 830 comprising at least one CPU, memory, and so forth; and a user input unit 836. At this scanner, execution of a prescribed program by a CPU of the controller 830 causes operation of an image processing unit 834 capable of carrying out processing with respect to various types of images and causes operation of a processing management unit 832 capable of managing execution of the various types of processing taking place at the scanner. At this scanner, as the drive system 808 causes movement of the CCD or the, for example, transmission original 804, the illumination system 802 irradiates the transmission original 804 with light, and light which has passed through the transmission original 804 is collected by the CCD of the image capturing circuit 806. The image capturing circuit 806 generates an analog image signal by converting the light collected by the CCD to an electrical signal. The A/D converter 810 converts this analog image signal to a digital image signal. This digital image signal is sequentially (but without limitation to the sequence given here) subjected as needed to: shading correction by the shading correction circuit 812, filtering processing for elimination of noise by the noise filter 814, color conversion processing by the color conversion circuit 816, and resolution conversion processing by the resolution conversion circuit 818. Furthermore, image data DI is output from the resolution conversion circuit 818, and this image data DI is stored at the image data storage unit 820. In addition, a CPU internal to the controller 830 may as needed carry out various types of image processing on this image data DI in accordance with, for example, the program mentioned above. More specifically, various types of image processing may be carried out thereon as needed by the image processing unit 834. The various types of processing described so far which take place at the scanner are controlled and managed by one or more CPUs internal to the controller 830 in accordance with, for example, the program mentioned above. Elaborating, execution of the various types of processing described above may be controlled by means of control information Ic output, for example, from the processing management unit 832.

Where a scanner such as that described above is to be used as a managed apparatus in accordance with the present invention, this may, for example, be implemented by means of hardware elements such as are shown at FIG. 2A and a prescribed program which is executed by CPU 11. In terms of functional components, such a usage management apparatus may comprise the equivalents of a user input unit 836, customer-side ticket processing unit 30, and one or more storage units 821 for storage of identification information, ticket management information, and so forth. In such a case, the user input unit 836 may be used as the input unit 117 for the usage management apparatus.

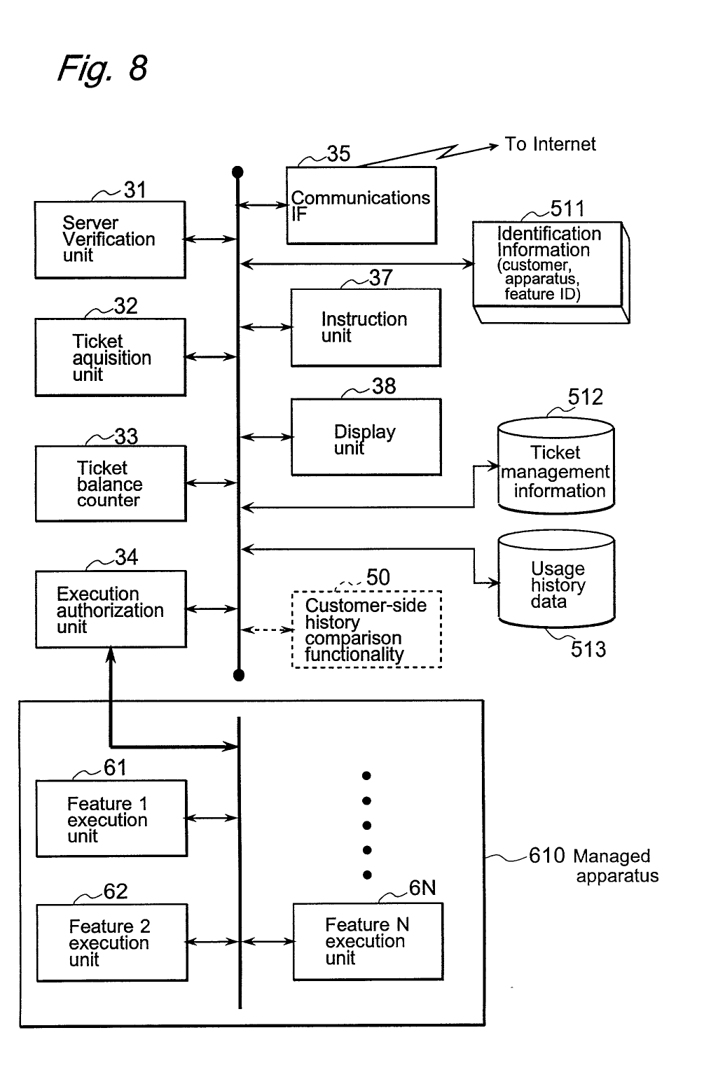

Such a customer-side ticket processing unit 30 may for example have a constitution such as is shown at FIG. 8, and may be capable of executing processing for mutual verification of identity during communication with a server 200 (network approval), of acquiring and managing tickets from a server 200 (ticket management), and of authorizing and denying use of one or more features requested to be used by a customer based on ticket management information (execution authorization). Such a customer-side ticket processing unit 30 is described in more detail below.

Upon occurrence of a request made by a customer through operation of the user input unit 836 for use of one or more features of the scanner that can be implemented through some combination of the various types of processing described above, an execution instruction le for execution of processing corresponding to that feature or features is, for example, sent to the processing management unit 832. While a conventional processing management unit might generate control information Ic based on this execution instruction Ie, causing execution of the corresponding processing, the processing management unit 832 of the present embodiment sends a request for use of the specific feature or features associated with the execution instruction le to the customer-side ticket processing unit 30. The customer-side ticket processing unit 30 determines whether to permit use of the requested feature or features based on ticket management information 512, the results of this determination being returned to the processing management unit 832 in the form of authorization information Ip. The processing management unit 832 controls execution of processing corresponding to the specific feature or features in accordance with this authorization information Ip. As a result, use of the scanner is managed in feature-dependent fashion in accordance with ticket management information 512.

Note that while it is possible in the above example for the controller 830 of the scanner serving as managed apparatus and for the usage management apparatus (i.e., the hardware by means of which the customer-side ticket processing unit 30 is implemented) to be provided separately, a constitution may also be employed where these share one or more, e.g., PC hardware, components.

1.1.3. Hardware Components of Server

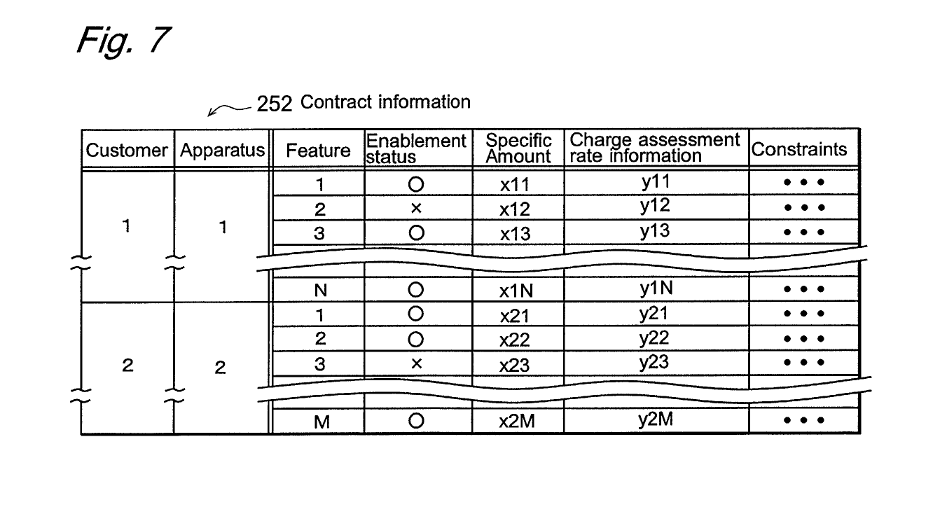

The server 200 in the feature-dependent charge assessment system described above may issue one or more tickets to one or more usage management apparatuses, the ticket or tickets authorizing use of one or more features of one or more managed apparatuses, and may carry out charge assessment processing in feature-dependent fashion with respect to usage of such managed apparatus or apparatuses based on issuance of such ticket or tickets. As shown at the example in FIG. 1, such a server 200 may comprise a data processing unit 201 comprising a CPU, memory, and so forth; an external storage unit 203 implemented, for example, by means of a hard drive unit; a communications interface unit (“communications IF”) 205 permitting communication with the usage management apparatuses 110, 120 by way of the Internet 700; and a display unit 208 implemented by means of, for example, a CRT, liquid crystal display, or the like. The data processing unit 201 of the server 200 may employ a constitution basically similar to that of the data processing unit 111 of the usage management apparatus 110, i.e., a constitution such as that shown at FIG. 2A. The external storage unit 203 is capable of storing identification information 251, contract information 252, post-charge-assessment information 253, and ticket issuance history data 254. As shown at FIG. 6, in the present example the identification information 251, which is prestored at the external storage unit 203, comprises apparatus IDs, customer IDs, and feature IDs for respectively identifying the managed apparatuses 610, 620 which are subject to charge assessment processing by the server 200, the customers using those managed apparatuses, and the features which those managed apparatuses possess, and further comprises passwords and information indicating whether use of respective features is enabled. The contract information 252 in the present example refers to information indicating the content of one or more contracts between a company or companies which sold the managed apparatuses 610, 620 and the one or more customers who is or are the respective user or users of the managed apparatuses 610, 620, a specific example of which as shown in FIG. 7 would be information indicating the apparatuses and features which each customer is permitted to use, charge assessment rates by feature, specific amounts representing the usage amounts authorized per unit issued ticket, and any constraints on use (e.g., limits on the number of tickets which can be issued, etc.). The post-charge-assessment information 253 in the present example refers to information indicating particulars related to charges assessed for features of the managed apparatuses which have actually been used, a specific example of which would be billable amounts for use of the managed apparatuses by the customers. The ticket issuance history data 254 in the present example refers to history information indicating sets of ticket data electronically representative of tickets issued for authorizing use of features of managed apparatuses and the times those tickets were issued, such ticket issuance history data 254 including information indicating the customer or customers, apparatus or apparatuses, feature or features, and usage amount or amounts for which use was authorized by each ticket.

1.1.4. Functional Components of Usage Management Apparatus

Execution by a CPU at the data processing unit 111 of a prescribed program (hereinafter “usage management program”) stored in RAM causes a usage management apparatus 110 in the present embodiment to emulate an apparatus having a constitution such as is shown at FIG. 8. More specifically, in such a case the usage management apparatus 110 may, for example, comprise functional equivalents of a server verification unit 31, a ticket acquisition unit 32, a ticket balance counter 33, an execution authorization unit 34, a communications IF 35, an instruction unit 37, a display unit 38, a storage unit for identification information 511, a storage unit for ticket management information 512, and a storage unit for usage history data 513. In such a case, the server verification unit 31, the ticket acquisition unit 32, and the ticket balance counter 33 may be implemented as a result of execution of the usage management program by the CPU; the execution authorization unit 34 may be implemented by means of the usage management program and an equipment I/O interface 18; and the communications IF 35, the instruction unit 37, and the display unit 38 may respectively correspond to the communications IF 115, the input unit 117, and the display unit 118 shown in FIG. 1. Specific examples of operation of these components are described below.

Furthermore, with continued reference to FIG. 8, in such a case a managed apparatus 610 may comprise functional equivalents of execution units 61, 62, . . . 6N capable of respectively executing features 1 through N, with execution of the several features 1 through N being managed by the execution authorization unit 34 of the usage management apparatus 110. It is moreover preferred that the present embodiment be provided with functionality for comparing the history of tickets issued by the server 200 with the history of tickets arriving at the usage management apparatus 110. A server provided with such functionality is, for example, described below with reference to the second embodiment.

A usage management program for implementing a usage management apparatus 110 constituted as described above with reference to FIG. 8 is typically provided in the form of a CD-ROM or other such recording medium whereon such program is stored. A customer user of a managed apparatus 610 might, for example, load in a CD-ROM drive (not shown) a CD-ROM which has been provided and which serves as recording medium for a usage management program, and the program could be read from the CD-ROM and installed on a hard drive unit 113. Alternatively or in addition thereto, such a usage management program sent by way of the Internet 700 may be received by a communications IF 15 and installed on such a hard drive unit 113. Moreover, a manufacturer might alternatively or in addition thereto install such a usage management program on such a hard drive unit 113 prior to shipment of such a usage management apparatus 110 together with a managed apparatus 610. Referring to FIG. 2, such a usage management program installed in such fashion on such a hard drive unit 113, upon being launched or otherwise started as a result of entry of a prescribed input sequence by a user at an input unit 117, might be transferred to RAM 12 internal to a data processing unit 111, where it is temporarily stored while being executed by a CPU 11 internal to the data processing unit 111.

While the following description is for convenience carried out in terms of an example in which a hardware apparatus is employed as managed product (managed apparatus), with the managed apparatus and the usage management apparatus in the present case being constituted as shown in FIG. 8, it should be understood that the invention is not limited hereto. For example, were an application program to be employed instead of or in addition to the hardware apparatus employed as managed product in the present embodiment, this could still be represented functionally by a constitution similar to that of the managed apparatus 610 in FIG. 8. Accordingly, the following description may also be applied to a feature-dependent charge assessment system which manages an application program having a plurality of features. Moreover, the following description may also be applied to a feature-dependent charge assessment system which manages an apparatus having features respectively implemented by hardware processing or software processing or by both hardware processing and software processing, such as is the case with the scanner described with reference to FIG. 3.

1.1.5. Functional Components of Server

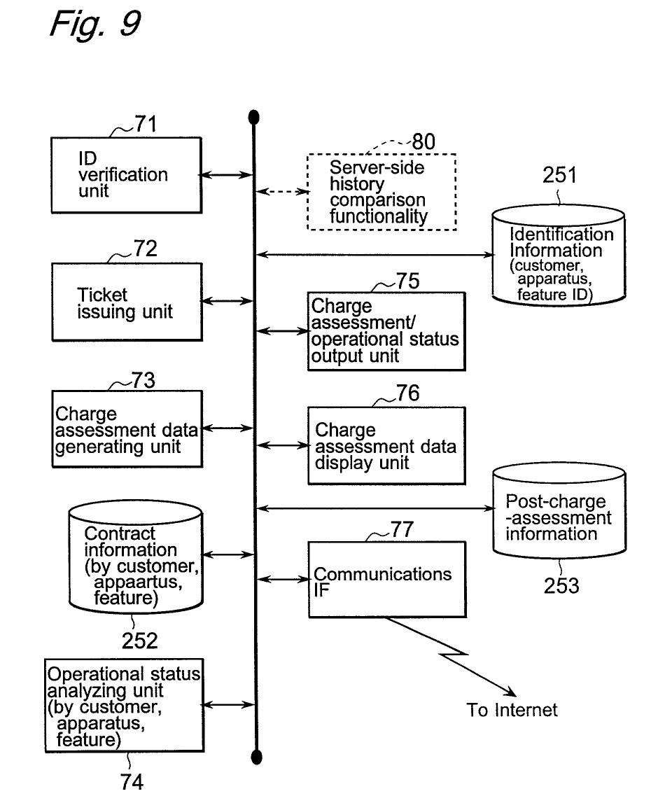

Execution of a prescribed program (hereinafter “charge assessment processing program”) by a CPU at the data processing unit 201 causes a server 200 in the present embodiment to emulate an apparatus having a constitution such as is shown at FIG. 9. More specifically, in such a case the server 200 may, for example, comprise functional equivalents of an ID verification unit 71, a ticket issuing unit 72, a charge assessment data generating unit 73, an operational status analyzing unit 74, a charge assessment/operational status output unit 75, a charge assessment data display unit 76, a communications interface unit (“communications IF”) 77, a storage unit for identification information 251, a storage unit for contract information 252, and a storage unit for post-charge-assessment information 253. In such a case, the ID verification unit 71, the ticket issuing unit 72, the charge assessment data generating unit 73, and the operational status analyzing unit 74 may be implemented as a result of execution of the charge assessment processing program by the CPU; the charge assessment/operational status output unit 75 and the charge assessment data display unit 76 may be implemented by means of the display unit 208 shown in FIG. 1; and the communications IF 77 may correspond to the communications IF 205 shown in FIG. 1. Specific examples of operation of these components are described below.

It is furthermore preferred that the present embodiment be provided with functionality for comparing the history of tickets issued by the server 200 with the history of tickets arriving at the usage management apparatus 110. A server provided with such functionality is, for example, described below with reference to the second embodiment. As storage of the ticket issuance history data 254 is described with reference to the second embodiment, below, detailed description thereof is omitted in the description of the present embodiment.

1.2. Operation

1.2.1. Operation During Startup of Managed Apparatus

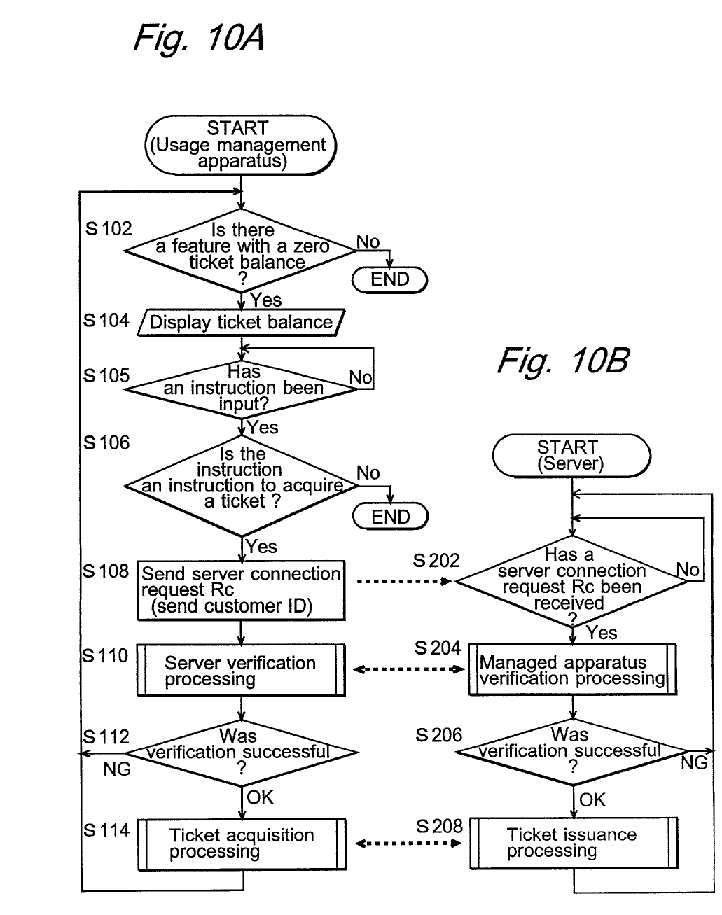

FIGS. 10A and 10B contain flowcharts showing operations occurring at the usage management apparatus 110 and the server 200 when the usage management apparatus 110 in the present example of the present embodiment is started up. At startup time, the usage management apparatus 110 carries out operations as shown at FIG. 10A in accordance with the aforementioned usage management program, and the server 200 carries out operations as shown at FIG. 10B in accordance with the aforementioned charge assessment processing program. Below, operations taking place at a feature-dependent charge assessment system associated with the present embodiment when the usage management apparatus 110 is started up are described with reference to FIGS. 8 through 10.

Upon startup of the usage management apparatus 110, the ticket balance counter 33 first refers to ticket management information 512 such as is shown at FIG. 5 to determine whether any of features 1 through N of the managed apparatus 610 have a zero ticket balance (step S102). If one or more features are as a result determined to have a zero ticket balance, then the display unit 38 displays the respective ticket balances of features 1 through N of the managed apparatus 610 (step S104). Note that it is also possible in a variation hereof to proceed to step S104 and display ticket balances even if ticket balances are all nonzero but are nonetheless less than some prescribed value for one or more features. Following display of ticket balances, processing goes into a standby state awaiting input, e.g., in the form of an input sequence entered at the instruction unit 37, of an instruction to acquire one or more tickets or an instruction not to acquire any tickets (step S105). Upon input of either such instruction while in this standby state, the instruction unit 37 determines whether the instruction which was input is an instruction to acquire one or more tickets (step S106). While in such standby state, the user of the managed apparatus 610 may look at the displayed ticket balance and may input an instruction to acquire one or more tickets for a feature or features having zero or small ticket balance by entering an input sequence at the instruction unit 37 (input unit 117), upon which in accordance with determination at step S106 the server verification unit 31 will send a server connection request Rc to the server 200 by way of the communications IF 35 (step S108). At such a time, the server verification unit 31 extracts from the identification information 511 a customer ID for identifying the customer using the managed apparatus 610 and includes that customer ID with the server connection request Rc which it sends. After such a server connection request Rc is sent, server verification processing begins (step S110).

On the other hand, the server 200 in the present example has been started up at a time prior to startup of the usage management apparatus 110, and at the time of startup of the usage management apparatus 110 the communications IF 77 is in a standby state awaiting receipt of a server connection request Rc (step S202). Upon receipt of a server connection request Rc while in such standby state, managed apparatus verification processing begins (step S204).

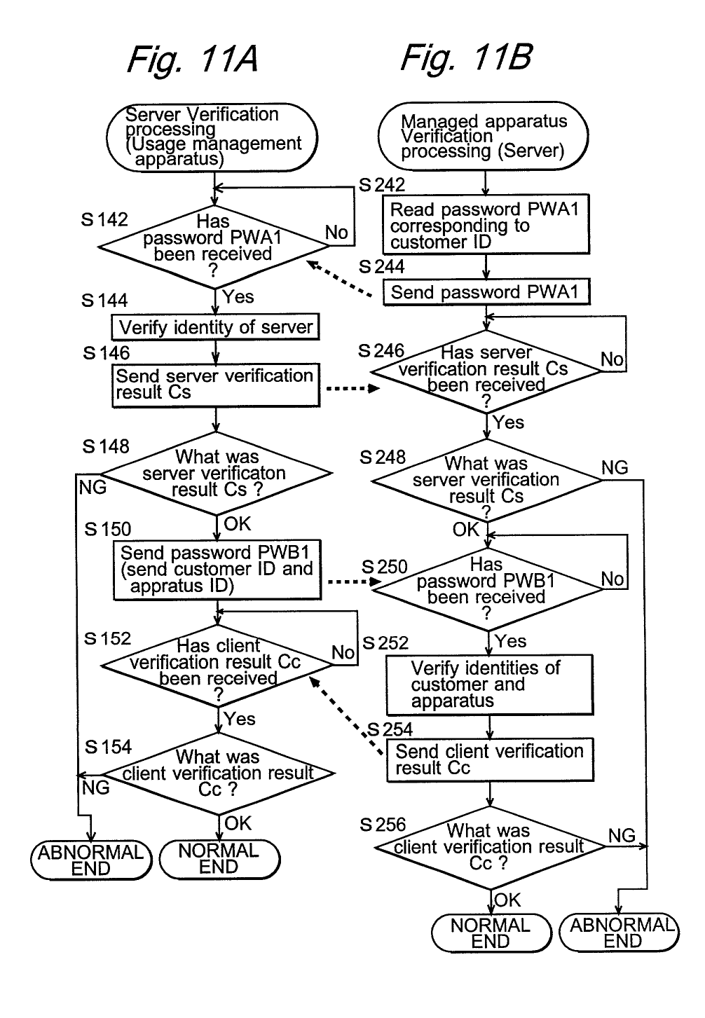

FIG. 11A is a flowchart showing a server verification processing sequence which may be executed at the usage management apparatus 110, and FIG. 11B is a flowchart showing a managed apparatus verification processing sequence which may be executed at the server 200. Such processing allows the server 200 and the usage management apparatus 110 to carry out mutual verification of identity. In a specific example, such mutual verification of identity may for example be implemented as a result of operations such as the following which might occur at the server verification unit 31 of the usage management apparatus 110 and the ID verification unit 71 of the server 200.

In the present example, the ID verification unit 71 of the server 200 may first extract a server password previously established for each customer (or for each apparatus) from identification information 251 (see FIG. 6) internal to the server 200 based on a customer ID included with a server connection request Rc received thereat (step S242). Furthermore, such an extracted password PWA1 may be encrypted and sent to the usage management apparatus 110 by way of the communications IF 77 (step S244). The server 200 may thereafter enter a standby state such that the communications IF 77 awaits receipt of a server verification result Cs from the usage management apparatus 110 (step S246).

At the usage management apparatus 110, upon receipt of such an encrypted password PWA1 by the communications IF 35, the server verification unit 31 may decrypt such password PWA1 and compare it with a server password contained within identification information 511 (see FIG. 4) internal to the usage management apparatus 110. Such a sequence of operations makes it possible for the usage management apparatus 110 to verify that it is in communication with a server 200 belonging to, for example, a company with which it has a contract (step S144). In such a case, such a verification result Cs would furthermore be sent to the server 200 by way of the communications IF 35 (step S146).

At the server 200, upon receipt of such a verification result Cs by the communications IF 77, the ID verification unit 71 could determine whether the usage management apparatus 110 has verified the identity of the server 200 based on this verification result Cs (step S248). If it was as a result determined that the identity of the server 200 had not been verified, the managed apparatus verification processing subroutine might return a result indicating unsuccessful completion of verification of identity (abnormal end). Conversely, if it was determined that the identity of the server 200 had been verified, the server 200 could enter a standby state such that the communications IF 77 awaits receipt of a password PWB1 from the usage management apparatus 110 (step S250).

On the other hand, at the usage management apparatus 110, after such a server verification result Cs had been sent, the server verification unit 31 could determine whether the identity of the server 200 had been verified based on this server verification result Cs (step S148). If it was as a result determined that the identity of the server 200 had not been verified, the server verification processing subroutine might return a result indicating unsuccessful completion of verification of identity (abnormal end). Conversely, if it was determined that the identity of the server 200 had been verified, the server verification unit 31 could extract from identification information 511 internal to the usage management apparatus 110 a password PWB1 for the customer who is the user of the managed apparatus 610, and could encrypt this and send it by way of the communications IF 35 (step S150). At such a time, the server verification unit 31 could extract both a customer ID and an apparatus ID from the identification information 511 and send these together with the encrypted password PWB1. The usage management apparatus 110 might thereafter enter a standby state such that the communications IF 35 awaits receipt of a client verification result Cc from the server 200 (step S152).

At the server 200, upon receipt by the communications IF 77 of the encrypted password PWB1 together with the customer ID and the apparatus ID, the ID verification unit 71 could decrypt that password PWB1 and could compare the decrypted password PWB1 with a customer password corresponding to that customer ID and that apparatus ID which is contained within the identification information 251. Such a sequence of operations makes it possible for the server 200 to verify that it is in communication with a customer and an apparatus with respect to which it has a contract (step S252). In such a case, such a verification result would furthermore be sent to the usage management apparatus 110 in the form of a client verification result Cc by way of the communications IF 77 (step S254). It could thereafter be determined based on the client verification result Cc whether the identities of the customer and the apparatus had been verified (step S256). If it was as a result determined that the identities of the customer and the apparatus had been verified, the managed apparatus verification processing subroutine might return a result indicating successful completion of verification of identity (normal end); but if the identities of the customer and the apparatus had not been verified, the managed apparatus verification processing subroutine might return a result indicating unsuccessful completion of verification of identity (abnormal end).

At the usage management apparatus 110, upon receipt of such a client verification result Cc by the communications IF 35, the server verification unit 31 could determine whether the server 200 has verified the identities of the customer and the apparatus (managed apparatus 610 and the user thereof) based on this verification result Cc (step S152). If it was as a result determined that the identities of the customer and the apparatus had been verified, the server verification processing subroutine might return a result indicating successful completion of verification of identity (normal end); but if the identities of the customer and the apparatus had not been verified, the server verification processing subroutine might return a result indicating unsuccessful completion of verification of identity (abnormal end).

At the usage management apparatus 110 in the present example, upon successful completion of the foregoing server verification processing (normal end), ticket acquisition processing begins (step S114); but upon unsuccessful completion of the foregoing server verification processing (abnormal end), processing returns to step S102. On the other hand, at the server 200 in the present example, upon successful completion of the foregoing managed apparatus verification processing (normal end), ticket issuance processing begins (step S208); but upon unsuccessful completion of the foregoing managed apparatus verification processing (abnormal end), processing returns to step S202.

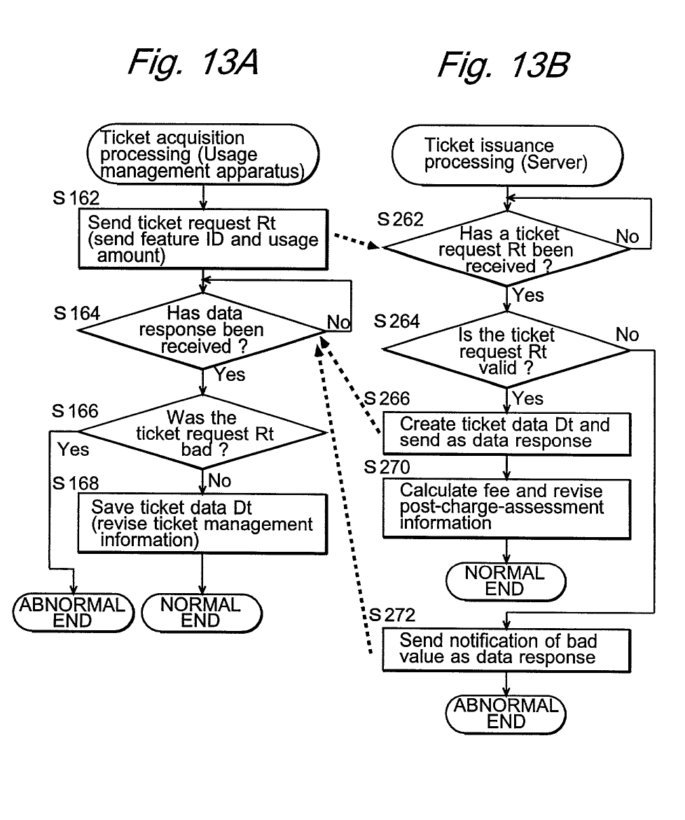

FIG. 13A is a flowchart showing a ticket acquisition processing sequence which may be executed at the usage management apparatus 110, and FIG. 13B is a flowchart showing a ticket issuance processing sequence which may be executed at the server 200. Such processing makes it possible for a request to be made to the usage management apparatus 110 for one or more tickets authorizing use of one or more of the plurality of features managed by the usage management apparatus 110 for which a ticket acquisition instruction is entered by means of an input sequence at the instruction unit 37 (see step S106), and makes it possible for one or more tickets to be issued by the server 200 in response thereto. In a specific example, such functionality may for example be implemented as a result of operations such as the following which may occur at the ticket acquisition unit 32 of the usage management apparatus 110 and the ticket issuing unit 72 of the server 200.

In such a case, the ticket acquisition unit 32 of the usage management apparatus 110 may for example first send a ticket request Rt to the server 200 by way of the communications IF 35 (step S162). At such a time, the ticket acquisition unit 32 extracts from identification information 511 internal to the usage management apparatus 110 one or more feature IDs for identifying the specific feature or features for which a ticket acquisition instruction has been entered as a result of an input sequence at the instruction unit 37, and includes the feature ID or IDs with the ticket request Rt which it sends.

Upon initiation of such ticket issuance processing, the server 200 enters a standby state such that the communications IF 77 awaits receipt of such a ticket request Rt from the server 200 (step S262). Upon receipt of such a ticket request Rt while in this standby state, the ticket issuing unit 72 refers to the identification information 251 at the server 200 (see FIG. 6) to determine whether the feature or features specified by the feature ID or IDs included with the ticket request Rt (hereinafter “specific feature,” but understood not to preclude multiple features) is or are valid features, a specific example of which would be determining for example whether the customer who is the user of that managed apparatus 610 has been previously authorized by contract to use such feature or features (step S264). If the ticket request Rt is as a result determined to be valid, then the ticket issuing unit 72 creates ticket data Dt electronically representative of the ticket or tickets in response to that ticket request Rt, and sends this in the form of a data response to the usage management apparatus 10 by way of the communications IF 77 (step S266). More specifically, in such a case the ticket issuing unit 72 may refer to contract information 252 internal to the server 200 (see FIG. 7), and in accordance with a previously received customer ID and apparatus ID and a feature ID corresponding to the aforementioned specific feature (step S250) may determine a specific amount representing a usage amount previously established for that specific feature, create data indicating that use of that specific amount of that specific feature is authorized, and send this in the form of ticket data Dt. Furthermore, such specific amounts can in such a case be respectively previously established for features 1 through N of the managed apparatus 610, and such amounts are expressible, for example, in terms of number of usage incidents, duration of use, equivalent usage data volume, amount of consumed or generated resources, and so forth. After the ticket data Dt has been sent in the present example, the charge assessment data generating unit 73 refers to feature-dependent charge assessment rate information contained within the contract information 252 to calculate a fee corresponding to that ticket data Dt—a specific example of which would be a fee corresponding to the aforementioned customer ID, apparatus ID, feature ID, and specific amount—and revises the post-charge-assessment information 253 based on that fee (step S270). In other words, an amount billable to the customer indicated by that customer ID would be increased by the amount of the fee so calculated. Following such a revision of post-charge-assessment information, the ticket issuance processing subroutine returns a result indicating successful completion of ticket issuance (normal end). However, if it is determined at step S264 that the ticket request Rt is invalid, then the ticket issuing unit 72 sends notification to the effect that the ticket request Rt is bad (“notification of bad value”) in the form of a data response to the usage management apparatus 110 (step S272). Following sending of such a notification of bad value, the ticket issuance processing subroutine returns a result indicating unsuccessful completion of ticket issuance (abnormal end).

Upon completion of such ticket issuance processing (after either a normal end or an abnormal end), processing at the server 200 returns to step S202, and steps S202 through S208 are thereafter repeated in loop fashion in the same manner as described above.

The usage management apparatus 110 may, after such a ticket request Rt has been sent, enter a standby state such that the communications IF 35 awaits receipt of a data response from the server 200 (step S164). Upon receipt of a data response by the communications IF 35 while in this standby state, the ticket acquisition unit 32 would determine whether the ticket request Rt which was sent is bad (step S166). If the ticket request Rt is as a result determined to be good, then the data response which was received is ticket data Dt, and the ticket acquisition unit 32 saves information indicative of this ticket data Dt (step S168). Elaborating, in such a case the ticket management information 512 (see FIG. 5) is for example revised by increasing by a specific amount the ticket balance corresponding to the specific feature indicated by the feature ID included with the ticket request Rt which was sent. In such a case, the ticket acquisition processing subroutine would return a result indicating successful completion of ticket acquisition (normal end). However, if it is determined at step S166 that the ticket request Rt is invalid, i.e., if a notification of bad value is received as data response at step S164, then the ticket acquisition processing subroutine would return a result indicating unsuccessful completion of ticket acquisition (abnormal end).

Upon completion of such ticket acquisition processing (after either a normal end or an abnormal end), processing at the usage management apparatus 110 returns to step S102, and steps S102 through S114 are thereafter repeated in loop fashion in the same manner as described above so long as at least one of features 1 through N managed by the usage management apparatus 110 has zero (or small) ticket balance and there has been no instruction to cancel ticket acquisition. If, during this period, all of features 1 through N managed by the usage management apparatus 110 come to have positive (or sufficiently large) ticket balances or there is an instruction to cancel ticket acquisition, then startup processing at the usage management apparatus 110 ends (steps S102, S106).

1.2.2. Operation During Use of Feature of Managed Apparatus

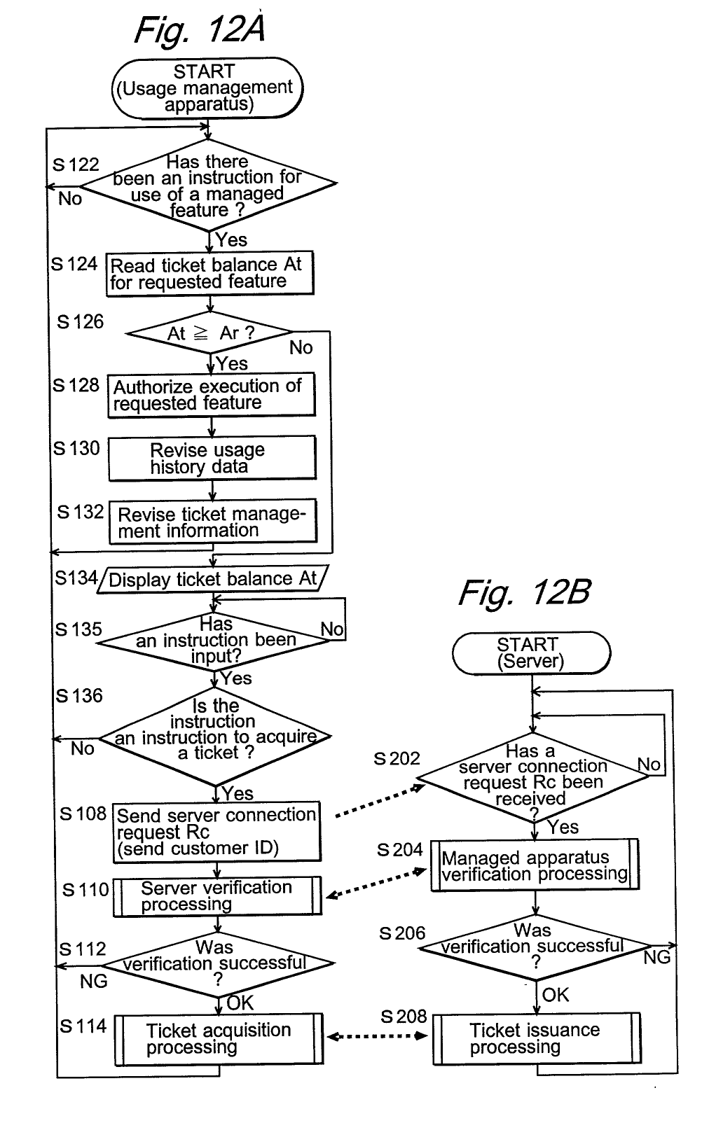

FIGS. 12A and 12B contain flowcharts showing operations occurring at the usage management apparatus 110 and the server 200 at a time of use of one or more features of the managed apparatus 610 in the present embodiment.

After the startup processing described above has ended, the usage management apparatus 110 carries out operations as shown at FIG. 12A in accordance with the aforementioned usage management program. The server 200 carries out operations in accordance with the aforementioned charge assessment processing program, starting up, as has already been described, prior to startup of the usage management apparatus 110, and entering a standby state immediately following the startup processing described above such that it awaits receipt of a transmission (step S202 at FIG. 12B).

Below, operations taking place at a feature-dependent charge assessment system associated with the present embodiment during use of one or more features of the managed apparatus 610 after the usage management apparatus 110 has completed the startup processing described above are described with reference to FIGS. 8, 9, 12A, and 12B.

After completing the startup processing described above, the usage management apparatus 110 enters a standby state awaiting input of an instruction at the instruction unit 37 for use of at least one feature of the features which managed apparatus 610 possesses that is a feature for which charge assessment is managed by the present system (hereinafter “managed feature”) (step S122). While the following description is for convenience carried out in terms of an example in which all of features 1 through N of the managed apparatus 610 are managed features, it should be understood that the invention is not limited hereto.

Upon input of an instruction for use of at least one managed feature while the usage management apparatus 110 is in the aforementioned standby state, the ticket balance counter 33 reads ticket balance or balances At for the feature or features for use of which an instruction was entered (hereinafter “requested feature,” but understood not to preclude multiple features) (step S124). Elaborating, in such a case a ticket balance At for the requested feature is extracted from ticket management information 512 internal to the usage management apparatus 110 (see FIG. 6). The ticket balance counter 33 then determines whether that ticket balance At is greater than or equal to an amount (hereinafter “requested amount”) Ar necessary for execution of the requested feature in accordance with the instruction at step S124 (step S126). The purpose of this is to determine whether to permit use of the requested feature based on the ticket balance At. For example, if ticket balance At were measured in number of usage incidents (number of times that the requested feature can be used), the requested amount Ar might normally be, say, “1,” with repeated input of an instruction to execute a requested feature at step S124 causing the requested amount Ar to be incremented by 1 with each such repetition.

In such a case, if it is determined at step S1126 that the ticket balance At for the requested feature is greater than or equal to the corresponding requested amount, then the execution authorization unit 34 authorizes execution of the requested feature (step S128). In a specific example, a signal for causing execution of the requested amount of the requested feature at the managed apparatus 610 might be sent from the execution authorization unit 34 to the managed apparatus 610, as a result of which that execution unit of feature 1 execution unit 61 through feature N execution unit 6N that corresponds to the requested feature would execute the requested amount Ar of the requested feature. In correspondence to such execution, the execution authorization unit 34 would revise the usage history data 513 by appending to that usage history data 513 information indicating, for example, a feature ID indicative of the requested feature, the usage amount at that time (here equal to the requested amount Ar), the time of use, and a customer ID indicative of the user (step S130). The ticket balance counter 33 would thereafter revise the ticket management information 512 by subtracting the requested amount Ar from the value of the ticket balance At read at step S124 to obtain a new ticket balance At, which is equal to the old ticket balance At less the required amount Ar, for the requested feature (step S132). After such revision of the ticket management information 512, processing would return to step S122.

In such a case, if it is determined at step S126 that the ticket balance At for the requested feature is less than the corresponding required amount, then the display unit 38 displays the ticket balance At for the requested feature (step S134). In such a case, processing goes into a standby state awaiting input in the form, for example, of an input sequence entered at the instruction unit 37 of an instruction to acquire one or more tickets or an instruction not to acquire any tickets (step S135). Upon input of either such instruction while in this standby state, the instruction unit 37 determines whether the instruction which was input is an instruction to acquire one or more tickets (step S136).

Upon input of an instruction to acquire one or more tickets while in this standby state, at least one ticket authorizing use of at least one specific amount of at least one requested feature is acquired from the server 200 in similar fashion as described above in connection with startup processing (steps S108-S114; steps S202-S208). In a specific example, a server connection request Rc would be sent from the usage management apparatus 110 to the server 200, upon which managed apparatus verification processing might first be carried out at the server 200 (step S204), with server verification processing being thereafter carried out at the usage management apparatus 110 (step S110). Such processing allows the server 200 and the usage management apparatus 110 to carry out mutual verification of identity. Upon successful completion (normal end) of such verification processing, ticket acquisition processing is executed at the usage management apparatus 110 (step S114) and ticket issuance processing is executed at the server 200 (step S208). Such processing makes it possible for ticket data Dt to be sent from the server 200 in response to a ticket request Rt from the usage management apparatus 110, and makes it possible for ticket management information 512 internal to the usage management apparatus 110 to be revised based on such ticket data Dt. This allows a ticket balance At for the requested feature at the ticket management information 512 to be increased by a specific amount indicated by the ticket data Dt. On the other hand, at the server 200 in the present example, after the aforementioned ticket data Dt is sent, a fee corresponding to that ticket data Dt is calculated and the post-charge-assessment information 253 is revised based on that fee.

At the server 200, after ticket issuance and revision of post-charge-assessment information 253 have been carried out as described above, processing returns to step S202, and steps S202 through S208 are thereafter repeated in loop fashion.

On the other hand, at the usage management apparatus 110, after ticket acquisition has been carried out as described above, processing returns to step S122 and goes into a standby state awaiting input of an instruction to use a managed feature. At such point in time, because the ticket balance At is sufficient to allow use of the aforementioned requested feature, upon input of an instruction to use the requested feature that requested feature is executed at the managed apparatus 610 (steps S126-S132).

1.2.3. Additional Operational Capabilities

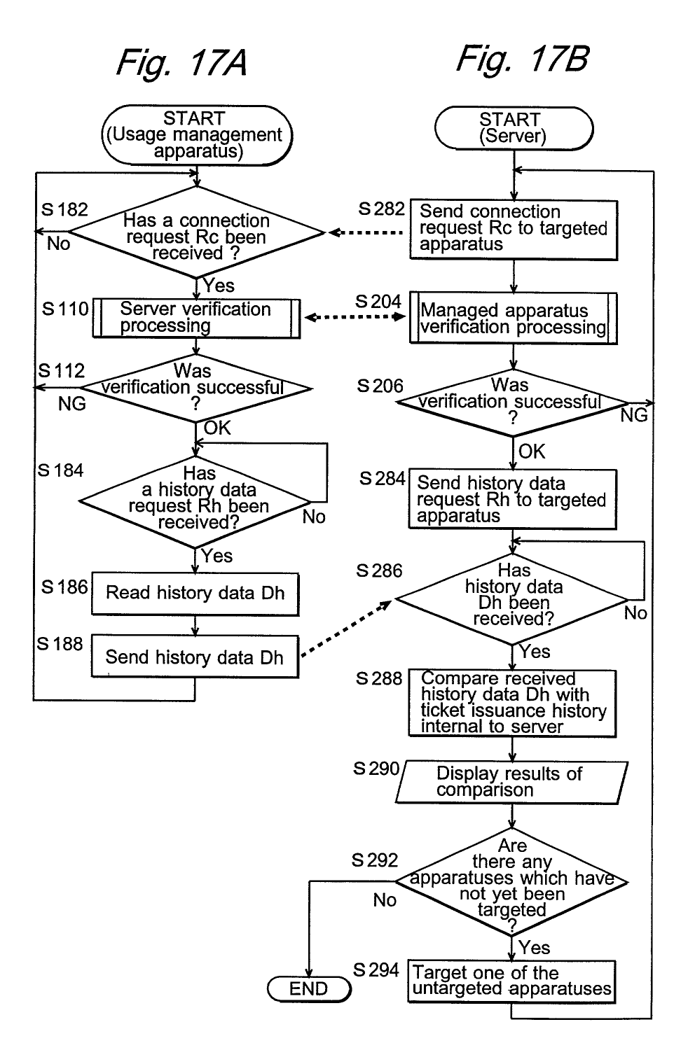

An operational status analyzing unit 74 at the server 200 might collect at the server 200 usage history data 513 stored at various managed apparatuses, use the usage history data so collected to calculate data indicative of the operational status or statuses of one or more managed apparatuses (e.g., usage periods and/or fractional uptime tabulated by customer, apparatus, and/or feature; charge assessment data tabulated by customer; etc.), and display such data at a charge assessment/operational status output unit 75. Note that such collection of usage history data 513 may be carried out, for example, by means of a sequence of operations more or less similar to the sequence of operations (collection of ticket arrival history data) indicated in FIGS. 17A and 17B and described below with reference to the second embodiment.

1.3. Benefits

In one or more embodiments of the present invention, because charge assessment is carried out with respect to usage of an apparatus following acquisition of the apparatus by a customer, the selling price at the time the apparatus is acquired can be kept low. Furthermore, in one or more embodiments of the present invention, charge assessment may be carried out such that charges are assessed only with respect to that feature or those features of the plurality of features which the acquired apparatus possesses that are actually used and such that charges are assessed in correspondence to the amount or amounts thereof actually used, with no charges, for example, being assessed for any unused feature or features. This accordingly has the benefit not only of allowing a customer to enjoy reduced initial apparatus acquisition cost but also reduced costs accompanying apparatus upgrades in connection with expansion and the like of required features. Elaborating, this, for example, allows the customer to enjoy reduced initial and ongoing costs despite acquisition of an apparatus or other such product equipped with more features than necessary at the time of acquisition, and yet have the ability to use one or more of the previously unused features as the need arises. Furthermore, assessed charges may be reduced in correspondence to usage amount when one or more previously heavily used features are later used less than they formerly were, and/or assessed charges may be such that no charge is assessed for one or more features which although formerly used are later not used at all. Where there is, for example, a change in the manner in which an acquired apparatus is used, i.e., there is a change in the feature or features which are required or in the amount or amounts of usage thereof, the present invention thus permits reduction in unproductive and excessive costs incurred due to such change.

Moreover, because in at least one embodiment of the present invention, authorization at a server 200 for use of one or more managed apparatuses may be carried out by way of customer-, apparatus-, and/or feature-dependent ticket issuance, fees for use of such apparatus or apparatuses may be set differently for different customers, apparatuses, and/or features. Such capability accordingly permits flexible setting of fees in correspondence to any of a variety of circumstances, such as for example the relationship with the customer, the level of demand for the various features, the situation with regard to supply of the various apparatuses, and so forth.

Furthermore, because in accordance with at least one embodiment of the present invention, apparatuses having an abundance of features can be sold at low price based on the assumption that charge assessment will be carried out in correspondence to usage of the apparatus following sale, this allows the manufacturer of such an apparatus to enjoy the benefit of being able to accommodate the needs of a wide variety of customers while keeping the number of models or versions to a minimum.

In addition, in one or more embodiments of the present invention a usage management apparatus manages at least one usage amount authorized in feature-dependent fashion by means of one or more authorized usage amounts through issuance of one or more tickets, and a determination is made with regard to whether to enable use of a feature or features at a managed apparatus based on at least one such authorized usage amount. As a result, in such a case the usage management apparatus need not communicate with a server 200 every time that the managed apparatus is used, permitting reduction in the amount of communication between server and usage management apparatus. Furthermore, because in at least one embodiment of the present invention assessment of charges for use of a managed apparatus is carried out at a server 200 based on one or more issued tickets, assured collection of the usage fee is permitted, making it possible to prevent fraudulent use.

In addition, in one or more embodiments of the present invention a feature-dependent usage history of a managed apparatus may be stored in the form of usage history data 513, and such usage history may furthermore contain one or more customer IDs and one or more times of use. Accordingly, by in such a case collecting at, for example, a server 200 such usage history data 513 stored at one or more of such managed apparatuses and employing an operational status analyzing unit 74 at the server 200 to analyze such data, it is possible, for example, to obtain marketing information, information capable of being used in connection with setting of fees and/or discounts for one or more users, and/or information capable of being used in connection with maintenance and/or repair of one or more managed apparatuses.

2. Second Embodiment

2.1. Constitution

A feature-dependent charge assessment system associated with a second embodiment of the present invention will now be described. The overall constitution of the feature-dependent charge assessment system of the present embodiment being similar to that of the first embodiment as shown in FIG. 1, identical reference numerals shall be used for corresponding components and detailed description thereof will be omitted in the interest of brevity. Furthermore, the hardware components of the usage management apparatus 110 and the server 200 in the feature-dependent charge assessment system of the present embodiment are likewise similar to those of the first embodiment, being for example as shown in FIG. 2. Note that while two usage management apparatuses are shown in the example at FIG. 1, in the description that follows description will likewise for convenience be made only with respect to the usage management apparatus 110 which manages managed apparatus 610, but such description should be understood to apply in representative fashion to as many usage management apparatuses as are present.

In the present embodiment, one or more ticket arrival histories may for example be stored at one or more usage management apparatuses 110, and one or more ticket issuance histories may for example be stored at a server 200. Furthermore, comparison of such histories makes it possible to conduct an audit to determine whether fraudulent use of a managed apparatus has occurred, the present embodiment differing from the first embodiment with respect to this point.

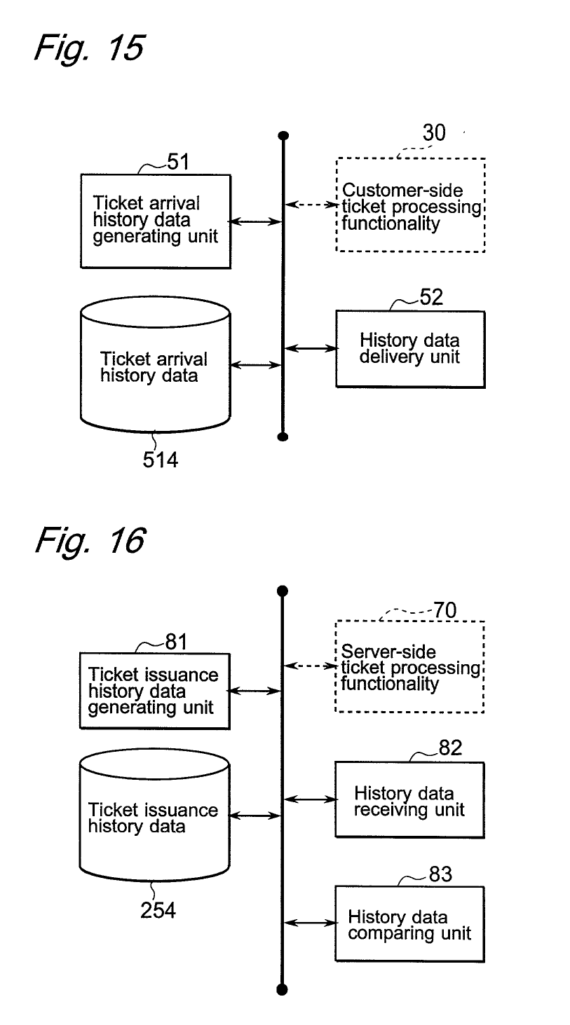

As was the case in the first embodiment, execution of a prescribed program (hereinafter “second usage management program”) by a CPU at the data processing unit 111 causes a usage management apparatus 110 in the present embodiment to emulate an apparatus having a constitution such as is shown at FIG. 8. In addition, however, the usage management apparatus 110 of the present embodiment has functionality supporting such comparison of histories in accordance with the second usage management program, those components (hereinafter “customer-side history comparison components” and indicated by reference numeral “50”) for implementing such functionality which are associated with the usage management apparatus 110 having, in terms of function, the equivalent of a constitution such as is for example shown at FIG. 15. That is, in a specific example of the present embodiment, a usage management apparatus 110 furthermore comprises a ticket arrival history data generating unit 51, a history data delivery unit 52, and a storage unit for ticket arrival history data 514. Note that the customer-side ticket processing unit 30 indicated with a broken line in FIG. 15 corresponds to the components indicated with a solid line at FIG. 8 (exclusive of the managed apparatus 610). Specific examples of operation of the components shown in FIG. 15 are described below.

Furthermore, as was the case in the first embodiment, execution of a prescribed program (hereinafter “second charge assessment processing program”) by a CPU at the data processing unit 201 causes a server 200 in the present embodiment to emulate an apparatus having a constitution such as is shown at FIG. 9. In addition, however, the server 200 of the present embodiment has functionality supporting such comparison of histories in accordance with the second charge assessment processing program, those components (hereinafter “server-side history comparison components” and indicated by reference numeral “80”) for implementing such functionality which are associated with the server 200 having, in terms of function, the equivalent of a constitution such as is for example shown at FIG. 16. That is, in a specific example of the present embodiment, a server 200 furthermore comprises a ticket issuance history data generating unit 81, a history data receiving unit 82, a history data comparing unit 83, and a storage unit for ticket issuance history data 254. Note that the server-side ticket processing unit 70 indicated with a broken line in FIG. 16 corresponds to the components indicated with a solid line at FIG. 9. Specific examples of operation of the components shown in FIG. 16 are described below.

2.2. Operation

As operations at the usage management apparatus 110 and the server 200 during startup of the usage management apparatus 110 in the present embodiment are similar to those described with respect to the first embodiment (see FIGS. 10A and 10B), description thereof will be omitted here in the interest of brevity.

2.2.1. Operations for Storage of History Data

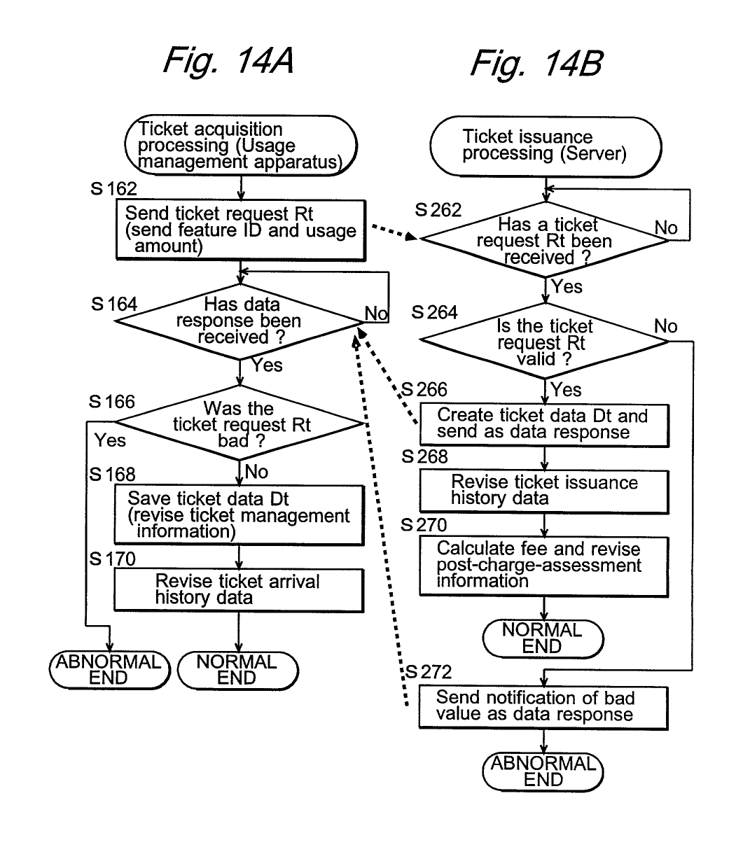

Operations at the usage management apparatus 110 and the server 200 during use of one or more features at the managed apparatus 610 in the present embodiment are likewise fundamentally similar to those of the first embodiment, being for example as shown in FIGS. 12A and 12B. In the present embodiment, ticket acquisition processing executed by the usage management apparatus 110 is such that, as shown at FIG. 14A, after ticket data Dt has been saved (step S168) the ticket arrival history data generating unit 51 may for example append to the ticket arrival history data 514 the specific amount or amounts and the specific feature or features indicated by that ticket data Dt, together with time stamp information applicable thereto. In the present example, such an operation permits revision of ticket arrival history data 514 (step S170). In the present example, insertion of such a step S170 makes it possible for ticket arrival history data 514 indicating the history of tickets arriving from the server 200 to be stored at the usage management apparatus 110. Furthermore, in the present embodiment, ticket issuance processing executed by the server 200 is such that, as shown at FIG. 14B, after ticket data Dt has been created and sent (step S266) the ticket issuance history data generating unit 81 may for example append to that ticket issuance history data 254 the specific amount or amounts and the specific feature or features indicated by that ticket data Dt, together with time stamp information applicable thereto. In the present example, such an operation permits revision of ticket issuance history data 254 (step S268). In the present example, insertion of such a step S268 makes it possible for ticket issuance history data 254 indicating histories of tickets issued to one or more managed apparatuses to be stored at a server 200.

2.2.2. Operations for Comparison of History Data

In the present embodiment, a prescribed program (hereinafter “comparison processing program”) may be periodically or at an appropriate time or times launched at the data processing unit 201, and a server 200 may periodically or at an appropriate time or times execute comparison processing such as is for example shown at FIG. 17B in accordance with such comparison processing program. In the present example, one or more usage management apparatuses for one or more managed apparatuses may execute processing (hereinafter “history data delivery processing”) such as is for example shown at FIG. 17A in correspondence to execution of comparison processing at the server 200. Specific examples of such comparison processing and history data delivery processing are described below with reference to FIGS. 15 through 17B.

At the server 200 in the present example, upon initiation of such comparison processing the communications IF 77, targeting any, say, one of the apparatus or apparatuses (managed apparatus or apparatuses) subject to charge assessment processing by the server 200, sends a connection request Rc to such targeted apparatus (step S282).

The usage management apparatus or apparatuses corresponding to the managed apparatus or apparatuses are for example always or at appropriate times monitoring for existence of a connection request Rc from the server (step S182), and in the event that a connection request Rc is sent from the server 200 to such a targeted apparatus the connection request Rc will be received by the communications IF 35 of the usage management apparatus (hereinafter “targeted usage management apparatus”) corresponding to that targeted apparatus. Upon receipt of a connection request Rc by the targeted usage management apparatus in the present example, server verification processing is executed (step S110). On the other hand, the server 200 in the present example, after sending the connection request Rc, executes managed apparatus verification processing (step S204). Such verification processing allows the server 200 and the targeted usage management apparatus to carry out mutual verification of identity. Upon successful completion (normal end) of such verification processing, the targeted usage management apparatus of the present example enters a standby state such that the communications IF 35 awaits receipt of a history data request Rh, and the server 200 sends a history data request Rh to the targeted apparatus (step S284). The server 200 of the present example, after such a history data request Rh has been sent, enter a standby state such that the history data receiving unit 82 awaits receipt of history data Dh by way of the communications IF 77.

At the targeted usage management apparatus in the present example, upon receipt of a history data request Rh from the server 200 the history data delivery unit 52 reads ticket arrival history data 514 from a storage unit (step S186), and sends this to the server 200 in the form of ticket arrival history data Dh by way of the communications IF 35. After such ticket arrival history data 514 has been sent, processing at the targeted usage management apparatus returns to step S182, and the targeted usage management apparatus again goes into a standby state awaiting receipt of a connection request Rc. Conversely, in the event of unsuccessful completion of server verification processing (abnormal end), neither reading nor sending of such ticket arrival history data 514 takes place and processing returns to step S182.

At the server 200 in the present example, upon receipt of ticket arrival history data Dh from the targeted usage management apparatus the history data comparing unit 83 reads from the ticket issuance history data 254 that ticket issuance history data corresponding to the ticket arrival history data Dh which was received, i.e., data indicative of a history of tickets issued for the targeted apparatus (hereinafter “targeted issuance history data”), and compares that targeted issuance history data with the ticket arrival history data Dh which was received (step S288). Results of such comparison may furthermore be displayed (step S290). The history data comparing unit 83 of the present example may thereafter investigate to determine whether there are any managed apparatuses that have not yet been targeted (step S292), and if there is such a managed apparatus that has not yet been targeted then one or more of such untargeted apparatus or apparatuses may be selected as a targeted apparatus or apparatuses (step S294). In such a case, processing might thereafter return to step S282, with execution of steps S282 through S294 being repeated in loop fashion until, for example, no untargeted apparatus remains. The server 200 may end comparison processing at a point in time when, for example, no untargeted apparatus remains.

2.2.3. Additional Operational Capabilities

As previously described, data indicative of one or more histories of one or more tickets issued to one or more usage management apparatuses may be stored in the form of ticket issuance history data 254 at a server 200 (step S268 at FIG. 14B). An operational status analyzing unit 74 at such a server 200 may use such ticket issuance history data 254 to calculate data indicative of the operational status or statuses of one or more managed apparatuses (e.g., usage periods and/or fractional uptime tabulated by customer, apparatus, and/or feature; charge assessment data tabulated by customer; etc.), and display such data at a charge assessment/operational status output unit 75.

2.3. Benefits

In one or more embodiments of the present invention, ticket arrival history data 514 (Dh) stored at one or more usage management apparatuses may be periodically or at an appropriate time or times sent to a server 200, permitting comparison of such ticket arrival history data 514 (Dh) with data (targeted issuance history data) corresponding thereto within ticket issuance history data 254 internal to the server 200. Because such comparison makes it possible to investigate whether there are inconsistencies in tickets sent and received during any given period, whether time stamp information between mutually corresponding ticket issuance and ticket arrival is in agreement, and makes it possible to perform other such checks, such comparison facilitates discovery of incidents of fraudulent use at one or more managed apparatuses.

Furthermore, in one or more embodiments of the present invention, one or more operational status analyzing units 74 at a server 200 are capable of obtaining data indicative of the operational status or statuses or the like of one or more managed apparatuses (e.g., data indicating charges assessed, fractional uptime, or the like, which may for example be tabulated by customer, apparatus, and/or feature), and particulars related to assessed charges may for example be changed based on such data. This for example makes it possible to offer such benefits as a reduction in fees (amount of assessed charges), i.e., a discount, for use of a particular feature if the fractional uptime for that feature exceeds some prescribed level. Such data indicative of operational status may furthermore be utilized in connection with maintenance and/or repair of one or more such managed apparatuses or may be used as marketing information or the like.

Moreover, in one or more embodiments of the present invention, because a server 200 is connected so as to be capable of communication with one or more usage management apparatuses by way of, for example, the Internet 700, billable amounts (e.g., an electronic bill or invoice) reflecting results of charge assessment or data indicative of operational status for the managed apparatus or apparatuses may be forwarded to the usage management apparatus or apparatuses corresponding to that managed apparatus or those managed apparatuses. Furthermore, in one or more embodiments of the present invention, the fact that at an arbitrary time or times a server 200 may, e.g., by way of the Internet 700, update data for certification of one or more customer IDs, apparatus IDs, passwords, or the like maintained at one or more usage management apparatuses permits increased security.

3. Other Examples and Variations

In one or more of the foregoing embodiments, one or more tickets are for example issued from a server 200 to a usage management apparatus prior to contemplated future use of one or more features at a managed apparatus, with charge assessment processing being carried out based on such ticket or tickets, and with use of such managed apparatus being managed in feature-dependent fashion in accordance with such ticket or tickets. In a specific example, information indicating one or more authorized usage amounts may be sent in the form of ticket data Dt from a server 200 to a usage management apparatus in advance of a contemplated future use of one or more features, with charge assessment processing being carried out based on one or more authorized usage amounts for one or more contemplated future usages. Alternatively or in addition to such advance-payment-type (before-the-fact) charge assessment, charge assessment may be carried out without issuance of tickets but in correspondence to a feature-dependent record of actual past usage at the managed apparatus. In a specific example, at a time after one or more features have actually been used at a managed apparatus, information indicating the feature or features used and the usage amount or amounts thereof may be sent in after-the-fact fashion from the corresponding usage management apparatus to a server 200, with the server 200 carrying out feature-dependent charge assessment based on such after-the-fact usage amount or amounts.

Furthermore, whereas in one or more of the foregoing embodiments one or more usage amounts authorized for one or more specific features per unit issued ticket may be established as one or more specific amounts in fixed fashion in accordance with contract information 252 (see FIG. 7), alternatively or in addition thereto one or more usage amounts may be designated in a ticket request Rt and one or more tickets may be issued such that one or more usage amounts for one or more features are authorized in the designated amount or amounts per unit issued ticket. In such a case, one or more upper limits with regard to issuable ticket quantity and/or one or more upper limits with regard to authorizable usage amount per unit issued ticket are preferably defined, for example, by means of the contract information 252.

In addition, whereas in one or more examples described with reference to the second embodiment ticket arrival history data 514 stored at one or more usage management apparatuses may be periodically or at an appropriate time or times sent to a server 200, alternatively or in addition thereto usage history data 513 stored at one or more usage management apparatuses may be periodically or at an appropriate time or times sent to a server 200 by means of a similar sequence of operations (see FIGS. 17A and 17B). In such a case, comparison of such usage history data 513 with data corresponding thereto at ticket issuance history data 254 internal to the server 200 permits discovery of incidents of fraudulent use at one or more managed apparatuses. Furthermore, in such a case it may be especially convenient for an operational status analyzing unit 74 at a server 200 to use such usage history data 513 instead of or in addition to ticket issuance history data 254 to calculate data indicative of the operational status or statuses or the like of one or more managed apparatuses (e.g., data indicating charges assessed, fractional uptime, or the like, which may for example be tabulated by customer, apparatus, and/or feature).

Whereas several preferred embodiments of the present invention and variations thereof have been described above, these examples have been presented merely for purposes of exemplary and representative description of the invention and it is not intended that the invention should be limited thereto. The present invention may be carried out in the context of a wide variety of modes and embodiments other than those specifically presented herein.

What is claimed is:

1. A charge assessment method carried out in the context of a system comprising a server which carries out charge assessment processing with respect to usage of a product having a plurality of features and a usage management apparatus which manages usage of the product and which is connected so as to be capable of communication with the server, said method comprising:
a) a usage amount management step wherein at least one amount of usage of the product is managed at the usage management apparatus in feature-dependent fashion;
b) a sending step wherein usage amount information indicating at least one feature-dependent usage amount of the product is sent from the usage management apparatus to the server before-the-fact if for a contemplated future use or after-the-fact if for a completed past use; and
c) a fee calculation step wherein a fee for usage of the product is calculated at the server in feature-dependent fashion based on the usage amount information.

2. A charge assessment method according to claim 1 further comprising:
a) a ticket issuing step wherein at least one ticket authorizing at least one specific feature-dependent amount of usage of the product is issued from the server to the usage management apparatus;
b) a determination step wherein
i) at least one usage amount for the product managed in feature-dependent fashion is treated as an authorized usage amount for a contemplated future use; and
ii) in response to a request from a user of the product for use of one or more of the plurality of features of the product a determination is made as to whether to permit use based on at least one authorized usage amount for at least one of the feature or features requested to be used; and
c) a usage authorization step wherein usage of at least one of the feature or features requested for use is authorized at the usage management apparatus only if it has been determined at the determination step that use of the feature or features is permitted;
d) the sending step being such that an issuance request requesting issuance of at least one ticket authorizing at least one specific amount of use of at least one specific feature of the product is sent to the server before-the-fact as usage amount information for a contemplated future use;
e) the ticket issuing step being such that ticket data electronically representative of the at least one ticket requested to be issued in the issuance request is sent from the server to the usage management apparatus in response to receipt of the issuance request at the server;
f) the fee calculation step being such that a fee for use of the at least one specific feature indicated by the ticket data which was sent is calculated based on the ticket data; and
g) the usage amount management step comprising
i) an upward revision step wherein responsive to receipt of the ticket data at the usage management apparatus at least one authorized usage amount of at least one of the plurality of features of the product which is a specific feature indicated by the received ticket data is increased by a specific amount indicated by the received ticket data; and
ii) a downward revision step wherein responsive to use of at least one of the plurality of features of the product the authorized usage amount of the at least one used feature is reduced by the amount that it was used.

3. A method for causing a server connected so as to be capable of communication with a usage management apparatus which manages usage of a product having a plurality of features to carry out charge assessment processing with respect to usage of the product, the method comprising:
a) a receiving step wherein usage amount information indicating at least one feature-dependent usage amount of the product is received from the usage management apparatus; and
b) a fee calculation step wherein a fee for usage of the product is calculated in feature-dependent fashion based on the usage amount information.

4. A method according to claim 3 further comprising:
a) a ticket issuing step wherein at least one ticket authorizing at least one specific feature-dependent amount of usage of the product is issued;
b) the receiving step being such that an issuance request requesting issuance of at least one ticket authorizing at least one specific amount of use of at least one specific feature of the product is received as the usage amount information;
c) the ticket issuing step being such that ticket data electronically representative of the at least one ticket requested to be issued in the issuance request is sent to the usage management apparatus in response to receipt of the issuance request; and
d) the fee calculation step being such that a fee for use of the at least one specific feature indicated by the ticket data which was sent is calculated based on the ticket data.

5. A method according to claim 4 further comprising:
a) an issuance history data storage step wherein ticket issuance history data comprising information indicating at least one product, at least one specific feature, and at least one specific amount for which use is authorized by the at least one ticket issued at the ticket issuing step is stored;
b) an arrival history data receiving step wherein ticket arrival history data comprising information indicating at least one product, at least one specific feature, and at least one specific amount for which use is authorized by ticket data received at the usage management apparatus is received from the usage management apparatus; and
c) a comparing step wherein the stored ticket issuance history data and the received ticket arrival history data are mutually compared.

6. A method according to claim 4 further comprising:
a) an issuance history data storage step wherein ticket issuance history data comprising information indicating at least one product, at least one specific feature, and at least one specific amount for which use is authorized by the at least one ticket issued at the ticket issuing step is stored;
b) a usage history data receiving step wherein usage history data comprising information indicating at least one product managed by the usage management apparatus and indicating at least one completed past feature-dependent usage amount of the managed product is received from the usage management apparatus; and
c) a comparing step wherein the stored ticket issuance history data and the received usage history data are mutually compared.

7. A method according to claim 3 or claim 4 further comprising a usage history data receiving step wherein usage history data comprising information indicating at least one product managed by the usage management apparatus and indicating at least one completed past feature-dependent usage amount of the managed product is received from the usage management apparatus.

8. A method for causing a usage management apparatus connected so as to be capable of communication with a server which carries out charge assessment processing with respect to usage of a product having a plurality of features to manage usage of the product, the method comprising:
a) a usage amount management step wherein at least one amount of usage of the product is managed in feature-dependent fashion; and
b) a sending step wherein usage amount information indicating at least one feature-dependent usage amount of the product is sent to the server before-the-fact if for a contemplated future use or after-the-fact if for a completed past use.

9. A method according to claim 8 further comprising:
a) a determination step wherein
i) at least one usage amount for the product managed in feature-dependent fashion is treated as an authorized usage amount for a contemplated future use; and
ii) in response to a request from a user of the product for use of one or more of the plurality of features of the product a determination is made as to whether to permit use based on at least one authorized usage amount for at least one of the feature or features requested to be used; and
b) a usage authorization step wherein usage of at least one of the feature or features requested for use is authorized only if it has been determined at the determination step that use of the feature or features is permitted;
c) the sending step being such that an issuance request requesting issuance of at least one ticket authorizing at least one specific amount of use of at least one specific feature of the product is sent before-the-fact as usage amount information for a contemplated future use; and
d) the usage amount management step comprising
i) a receiving step wherein ticket data electronically representative of the at least one ticket issued by the server in response to the issuance request is received;
ii) an upward revision step wherein responsive to receipt of the ticket data at the receiving step at least one authorized usage amount of at least one of the plurality of features of the product which is a specific feature indicated by the received ticket data is increased by a specific amount indicated by the received ticket data; and
iii) a downward revision step wherein responsive to use of at least one of the plurality of features of the product the authorized usage amount of the at least one used feature is reduced by the amount that it was used.

10. A method according to claim 9 further comprising:
a) an arrival history data storage step wherein ticket arrival history data comprising information indicating at least one product, at least one specific feature, and at least one specific amount for which use is authorized by ticket data received at the usage management apparatus is stored; and
b) an arrival history data sending step wherein the stored ticket arrival history data is sent to the server.

11. A method according to claim 8 further comprising:
a) a usage history data storage step wherein usage history data comprising information indicating at least one product managed by the usage management apparatus and indicating at least one completed past feature-dependent usage amount of the managed product is stored; and
b) a usage history data sending step wherein the stored usage history data is sent to the server.

12. A method according to claim 9 further comprising:
a) a usage history data storage step wherein usage history data comprising information indicating at least one product managed by the usage management apparatus and indicating at least one completed past feature-dependent usage amount of the managed product is stored; and
b) a usage history data sending step wherein the stored usage history data is sent to the server.

13. A program for causing a computer to execute a method according to any one of claims 8 through 12;
a) the computer being connected so as to be capable of communication with the server; and
b) the computer functioning as the usage management apparatus.

14. A usage management apparatus which is connected so as to be capable of communication with a server that carries out charge assessment processing with respect to usage of a product having a plurality of features and which manages usage of the product, the usage management apparatus comprising:
a) usage amount management means for managing at least one usage amount of the product in feature-dependent fashion; and
b) sending means for sending to the server, before-the-fact if for a contemplated future use or after-the-fact if for a completed past use, usage amount information indicating at least one feature-dependent usage amount of the product.

15. A usage management apparatus according to claim 14 further comprising:
a) determination means
i) for treating at least one usage amount for the product managed in feature-dependent fashion by the usage amount management means as an authorized usage amount for a contemplated future use; and
ii) for, in response to a request from a user of the product for use of one or more of the plurality of features of the product, determining whether to permit use based on at least one authorized usage amount for at least one of the feature or features requested to be used; and
b) usage authorization means for authorizing usage of at least one of the feature or features requested for use only if the determination means has determined that use of the feature or features is permitted;
c) the sending means sending before-the-fact as usage amount information for a contemplated future use an issuance request requesting issuance of at least one ticket authorizing at least one specific amount of use of at least one specific feature of the product; and
d) the usage amount management means comprising
i) receiving means for receiving ticket data electronically representative of the at least one ticket issued by the server in response to the issuance request;
ii) upward revision means for, responsive to receipt of the ticket data by the receiving means, increasing by a specific amount indicated by the received ticket data at least one authorized usage amount of at least one of the plurality of features of the product which is a specific feature indicated by the received ticket data; and
iii) downward revision means for, responsive to use of at least one of the plurality of features of the product, reducing the authorized usage amount of the at least one used feature by the amount that it was used.
